(19) United States
(12) Patent Application Publication
(10) Pub. No.: US 2009/0178935 A1
(43) Pub. Date: Jul. 16, 2009

(54) Miniaturised Biosensor with Optimized Amperometric Detection

(75) Inventors: Frederic Reymond, Lutry (CH); Joel Stephane Rossier, Vionnaz (CH); Patrick Morier, Blonay (CH)

Correspondence Address: HOWSON & HOWSON LLP, 501 OFFICE CENTER DRIVE, SUITE 210, FORT WASHINGTON, PA, 19034, US

(73) Assignees: DIAGNOSWISS S.A., Monthey (CH); BIOMERIEUX S.A., Marcy-l'Etoile (FR)

(21) Appl. No.: 12/296,639

(22) PCT Filed: Mar. 29, 2007
(86) PCT No.: PCT/EP2007/002793

§ 371 Date: Oct. 9, 2008

(30) Foreign Application Priority Data
Apr. 10, 2006 (GB) 0607205.2

(51) Int. Cl. G01N 27/26

(52) U.S. Cl. 205/777.5; 205/775; 204/400; 204/412; 205/780.5

(57) ABSTRACT

A method to optimize the amperometric detection in a microsystem consists in limiting the detection to times when the diffusion layer (18-20) of the analyte to detect remains smaller than the microchannel (7) height. The charge detected during the second part of the amperometric measurement (which corresponds to the integral of the measured current over the corresponding time period) can also be considered so as to remove the contribution of the capacitive current and, when applicable, of the current resulting from the reduction or oxidation of the analyte molecules present in a recess above the electrode at the beginning of the detection. A microfluidic amperometric sensor for performing the method comprises at least one microchannel (7) having at least one electrode (15-17), integrated in one wall of the microchannel, and having a characteristic length or radius which is smaller than half the microchannel height.

### FIELD OF THE INVENTION

The present invention relates to amperometric sensors for the analysis and detection of biological or chemical compounds in small volume samples, and to methods of fabricating and using the sensors.

### BACKGROUND OF THE INVENTION

Miniaturisation of analytical devices has become a very attractive field of interest in analytical chemistry mainly for two distinct reasons, namely reducing the time needed for single analyses and reducing the volumes of samples and reagents as well as the quantity of wastes. Many developments have been made in recent years in the fabrication of microfluidic devices and their use for the development of various types of assays.

One of the bottlenecks of miniaturisation is to ensure a low limit of detection despite the tiny volume of the microfluidic devices and hence the small number of molecules present in these systems. Different detection means, including optical, mass spectrometric or electrochemical detection means have been implemented with success, albeit to detect rather large concentrations of analyte. For example, many analytical systems already exist for the detection of glucose, with a clear trend towards the reduction of the sample volumes. Indeed, one electrochemical glucose sensor developed by Therasense (see US 2004/0225230 A1) can already be considered as a miniaturised device since it performs coulometric detection of glucose in only 0.3 microL of capillary blood. These glucose sensors are only adapted to pure enzymatic reactions (no fluid handling required except capillary fill), and restricted to large analyte concentrations. Indeed, in such small sample volumes, coulometric detection is claimed to be more accurate than other electrochemical detection techniques because it enables one to measure all of the available analyte in the sample. Actually, most blood glucose monitoring systems use an amperometric technology, which measures only a fraction of the glucose in a blood sample, which limits the signal that can be obtained from a small sample size. As coulometric detection is strongly dependent on the geometry of the device, it would thus be desirable for many analytical applications to have amperometric sensors having sufficient sensibility and accuracy to probe, monitor or determine the quantity of analytes of interest in small volumes.

Detecting low concentrations necessitates optimisation of the geometry of the microfluidic device as well as of the method of detection. The geometry and path length of the detection window directly affects the sensitivity in systems relying on optical detection, whereas the detection performances depend directly on the shape and position of the electrodes as well as on the geometry around the electrode in electrochemical sensors. These factors represent an important limitation for the performance of miniaturised analytical systems and in particular for electrochemical microsensors that are usually considered to be of relatively low sensitivity compared for instance to fluorescence-based detection systems.

One important parameter affecting the performances of electrochemical microsensors is that no diffusion layer can generally be established above the electrode because of the absence of natural convection. A microsystem is not infinite in the dimension orthogonal to the electrode surface, so that the current never reaches a constant value (steady-state current) but always decreases with time. The whole profile of concentrations continuously evolves due to consumption of the electroactive species at the electrode(s), thereby leading to a weakening of the solution and hence to a decrease of the measurable current. This limits the sensitivity of the detection, and it is thus the aim of the present invention to provide electrochemical microsensors and methods that enable one to measure the largest possible currents by optimisation of the geometry of the microsystem and/or of the amperometric detection method.

Given the wide acceptance of electrochemical sensors in glucose testing, notably due to the easy handling of the devices, the relatively simple infrastructure required to perform the assays and the wide possibilities of parallelising the analysis and given the wide interest in using miniaturised systems due to smaller time-to-result, low volume consumption and large multiplexing capabilities, it would be highly desirable and convenient to develop electrochemical microchips capable of performing accurate and sensitive analysis of low concentration analytes. It would also be desirable to develop methods for manufacturing and for using microchip-based electrochemical sensors capable of optimising the signal that can be detected so as to improve the detection limit of the assays and increase their reproducibility.

### SUMMARY OF THE INVENTION

The present invention provides a novel method for the detection and quantification of an analyte in low volumes by amperometric measurement, as well as microchip-based electrochemical sensors for optimised amperometric detection of an analyte. In general, the method and device of the present invention enable the detection of low concentrations of electroactive compounds in a microfluidic system comprising a microstructure (generally a microchannel) having at least one working electrode in one wall of said microstructure so as to be in direct contact with a solution present in said microstructure. The invention also includes a method for fabricating miniaturised microfluidic sensors adapted to provide optimised amperometric detection. The analytical devices of this invention find many applications in biological and/or chemical analysis, and they are particularly well suited for enzymatic, antigen, antibody, protein, peptide, immunological, oligonucleotide, DNA, cellular, virus or pathogen assays.

In the present invention, the following definitions define the stated term:

A “microchip”, a “chip”, a “microsystem” or a “microfluidic device” as used herein is any system comprising at least one miniaturised structure (or “microstructure”) which is a reaction or separation chamber or a conduit such as a micro-well, a micro-channel, a capillary, a micro-hole or the like, not limited in size and shape but enabling micro-fluidic manipulations; the microstructure(s) is(are) fabricated by any means e.g. embossing, injection moulding, chemical etching, plasma etching, laser ablation, polymer casting, UV Liga, integration of a spacer between two material layers or any combination thereof; in a preferred embodiment, the microchip is made of a multilayer body comprising at least one layer in which the microstructure(s) is(are) fabricated (hereinafter referred to as “chip support” or “microstructure support”), electrical conducting tracks and/or pads for the connection of the electrode(s) and a cover layer (as for instance a lamination layer, a polymer foil or a glass slide) used to seal the microstructure; in a more preferred embodiment, the microchip comprises a chip support made of a polymer material (e.g. polyethylene, polystyrene, polyethylene terephthalate, polymethylmethacrylate, polyimide, polycarbonate, polyurethane, liquid crystalline polymer or polyolefines) and the cover layer is also made of a polymer material, while the electrical conducting tracks and/or pads are made of a metal or an electrically conductive ink (e.g. copper (coated or not with gold) or a carbon ink dopped with silver and/or silver chloride); in another embodiment, the microchip comprises a plurality of microstructures (as for instance an array of microchannels or a network of microchannels, or a series of micro-wells or micro-holes);

The “height of the microstructure” is the distance between the surface of the microstructure comprising the integrated electrode(s) in at least one of its wall portions and the opposite wall of the microstructure; in the case of recessed electrodes, the height of the recess is not included in the microstructure height;

A “microelectrode” is an electrode of which one of the characteristic dimensions—also hereinafter referred to as characteristic length—(namely the radius in the case of microdiscs or microhemispheres, the band width in the case of microbands, etc.) is of the order of few tens of micrometers or less;

A “working electrode” is an electrode at which an analyte is oxidised or reduced by transfer of an electron between the electrode and the analyte, with or without the aid of a redox mediator;

A “counter electrode” is an electrode which is paired with the working electrode(s) and through which passes an electrochemical current that has the same magnitude as but the sign opposite to the current passing through the working electrode(s).

A “reference electrode” is an electrode serving to fix the potential during an electrochemical measurement;

A “pseudo-reference electrode” is a reference electrode that also functions as a counter-electrode (i.e. a counter/reference electrode); by extension, the term “reference electrode” as used herein also includes the pseudo-reference electrode, unless otherwise specifically stated in the description;

An “analyte” is any compound of interest that is present in the sample and that is intended to be detected or monitored, quantitatively or qualitatively, either directly, or indirectly by way of e.g. a chemical or biological reporter like an antigen, an antibody, an enzyme, an oligonucleotide, etc.;

“Amperometry” is any electrochemical detection technique consisting of measuring a current from a reduction and/or an oxidation at the working electrode(s); “amperometry” thus comprises chrono-amperometry, pulse voltammetry and Cottrell-type measurements. In amperometry, a potentionstat is used to force a current through a working electrode until the potential between said working electrode and the reference electrode reaches the desired potential value set in the potentiostat; for simplification, we will speak hereinafter of a “potential application” when a given potential value is desired to be reached at an electrode and, following the usual electrochemical jargon, it will be generally said hereinafter that this potential is applied by the potentiostat to the working electrode(s);

An “electrochemical microsensor” or “electrochemical microchip” is a device designed and adapted to measure the concentration of and/or to detect the presence of an analyte by way of electrochemical oxidation and/or reduction reactions. These reactions are transduced to an electrical signal that can be correlated to an amount or concentration of the analyte;

A compound is “immobilized” on a surface when it is entrapped on or physically or chemically bound to the surface.

The “consumption layer” is defined here as the volume adjacent to an electrode in which a gradient of analyte concentration is created due to the consumption of this analyte at the electrode upon application of the potential required to reduce and/or oxidise this analyte; beyond the consumption layer, the analyte concentration remains constant, whereas the analyte concentration is zero at the electrode surface when the reduction and/or oxidation reaction occurs; when there is no redox reaction at the electrode, the analyte concentration is homogeneous within the microsensor, and a concentration gradient is created only by the diffusion of the analyte molecules reacting at the electrode.

The “thickness of the consumption layer”, 1, is defined here as the length of the concentration gradient resulting from the analyte consumption at the electrode upon potential application; the thickness of the consumption layer thus varies with time and it is dependent on the geometry of the device; as diffusion is isotropic, the thickness of the consumption layer determines a volume adjacent to the electrode in which there is a gradient of analyte concentration; the thickness of the consumption layer is thus given by the distance between the electrode surface and the locus where the concentrations of the oxidised and, respectively, reduced species are equal to their initial concentrations, i.e. their concentrations at the time where the potential required for the redox reaction is switched on.

In Microsystems where the molecular fluxes are controlled by diffusion (i.e. when migration and forced convection are zero or can be neglected), the consumption of an analyte at an integrated electrode creates a concentration gradient which continuously evolves with time during the potential application. The volume encompassing this concentration gradient defines a “consumption layer” above the electrode surface where the analyte concentration differs from its initial concentration, i.e. from its concentration at the time where the potential required for inducing reduction or oxidation of the analyte at the electrode is applied. Similarly to what happens with a microelectrode placed in an infinite or semi-infinite environment, this consumption layer has a hemispherical shape in the case of microdisc and microhemisphere electrodes and a hemicylindrical shape in the case of microband electrodes. In a microsystem however, the height above the electrode is restricted to few tens of micrometers or less (and hence the volume of solution around the electrode is restricted to few nL or less), so that there is not enough space to allow natural convection to take place. Thus, there is no possible renewal of analyte molecules by natural convection, so that no diffusion layer can be established. As a consequence, the measured current does not reach a steady state, but it continuously decreases with time due to the consumption at the electrode.

The consumption of analyte molecules at the electrode generates a concentration gradient which evolves with time and in which analyte molecules diffuse towards the electrode. This concentration gradient determines a volume around the electrodes where the analyte concentration is different from its initial concentration. By analogy with the well-known notion of a diffusion layer in an infinite or semi-infinite environment, the volume defined by the concentration gradient above the electrode is referred hereinafter as the “consumption layer”, and this consumption layer represents the volume in which the analyte is depleted during the application of the potential required to induce the reduction or oxidation of the analyte.

As the concentration gradient is controlled by diffusion, the thickness of the consumption layer, l, can be calculated using the Nernst-Einstein equation which reads:

l=2(D t)^{1/2} Eq. 1

where D is the diffusion coefficient of the analyte molecules (in m²/s) and t is the time (in second) which corresponds here to the duration of the application of the potential required to reduce or oxidise the analyte at the electrode.

Being purely diffusion-controlled, the analyte consumption at the microelectrode induces a spherical diffusion flux above the electrode which thus has a hemicylindrical or hemispherical shape depending on the microelectrode geometry (which leads to a large increase in the mass transfer compared to large electrodes and hence in the measurable current). The consumption layer above a microelectrode in a microsystem follows this spherical diffusion regime and thus has a hemispherical shape in the case of microdisc or microhemisphere electrodes, or a hemicylindrical shape in the case of microband electrodes.

Otherwise, when the electrode(s) is(are) recessed, two diffusion geometries are involved: on one hand, linear diffusion in the microcylinder (or microcone) defined by the recess above the recessed electrode(s) and, on the other hand, hemispherical diffusion such as that obtained on a microdisc electrode. In this configuration, the consumption layer evolves according to these two diffusion regimes, and, on the time scale of amperometric measurements, the recessed microdisc electrode can be considered to behave like a microelectrode for which the apparent thickness of the diffusion layer is lₐₚₚ=L+l, where L is the height of the recess above the electrode.

In a microstructure such as a microchannel with integrated electrode(s), the volume of solution above the electrode(s) is limited, so that the equiconcentration curves in the consumption layer rapidly change from hemispheres or hemicylinders above the electrode(s) to curves corresponding to the cross-section of the microchannel, because the analyte is progressively consumed during the detection, thereby leading to the depletion of the entire volume above the electrode(s). The diffusion regime thus changes from spherical above the electrode(s) to linear along the microchannel length, thereby decreasing the mass transfer, the flux of reduced or oxidised species towards the electrode(s) and hence the measurable current. The sensitivity of the sensor is thus limited by the depletion of the analyte within the microstructure during the detection and by the mix between hemispherical and linear diffusion regimes. An aim of the present invention is thus to provide an electrochemical microsensor in which the geometry of the microstructure and of the integrated working electrode(s) is adapted to detect analyte molecules submitted to hemi-spherical or hemi-cylindrical diffusion only, by inducing consumption layer(s) above the electrode(s) having a thickness smaller than the microstructure height above these electrode(s). When the sensor includes a plurality of integrated electrodes, these electrodes are also positioned in such a manner that the consumption layers above adjacent electrodes do not overlap. In addition, the invention provides methods enabling one to measure the largest possible currents by maximising the diffusion flux of analyte molecules to the electrode(s). In a preferred method, the invention is adapted to deliver electrochemical signals that are not affected by the capacitive current. When the sensor includes integrated recessed electrode(s), the method of the invention is further adapted to remove the signal resulting from the detection of the analyte molecules present in the recess at the beginning of the detection. This invention therefore provides methods wherein the measured currents are maximised, thereby optimising the sensitivity of the sensor, while reducing the background signals and the reproducibility errors due to the capacitive currents and/or to the detection of the analyte molecules present in the recess(es) above the electrode(s).

The sensors of the present invention thus provide microchip-based analytical systems comprising at least one microstructure (most preferably a covered microchannel) that has geometrical characteristics enabling optimum amperometric detection of an electroactive analyte, i.e. an analyte liable to reduction or oxidation reactions (redox reactions). It is another aim of the present invention to provide a method of amperometrically detecting an analyte in a microchip with maximum sensitivity.

From a first aspect, the present invention provides a microchip system comprising at least one microstructure comprising at least one working electrode having precise size and location, said working electrode defining a wall portion of the microstructure which is in direct contact with a solution containing the electroactive species to detect. The shape of the microstructure and the position and size of the working electrode(s) integrated within the microstructure are adapted to enable a significant depletion of the analyte present in the segment of solution inside the microstructure—and in particular in the few micrometers around the working electrode(s)—and to avoid the total depletion of the channel height during the detection time scale, thereby remaining always with a hemispherical or cylindrical diffusion regime and preventing the electrochemical signal from being limited by linear diffusion in the microchannel direction.

In a preferred embodiment, the microstructure is a covered microchannel or an array or network of covered microchannels, the shape and dimensions of said microchannel(s) as well as the size, shape and location of the working electrode(s) integrated in said microchannel(s) are designed and configured in such a way that only the electroactive analyte submitted to a hemispherical diffusion regime can be measured at the working electrode(s) during the time scale of the amperometric detection step. In other words, the technical and geometrical characteristics of the microchannel(s) and integrated working electrode(s) are selected in such a manner that only part of the microchannel is depleted during the amperometric measurements and that there is insufficient time to establish a linear diffusion regime along the microchannel length. In a further preferred embodiment, the microchannel(s) and working electrode(s) shapes and dimensions are such that the electroactive analyte is depleted during the amperometric measurements over a maximum distance corresponding to the microchannel height above the electrode(s). In a still more preferred embodiment, the microchannel height is at least twice the “characteristic length” (or “characteristic dimension”) of the integrated working electrode(s) r (namely the radius in the case of microdisc(s) or microhemisphere(s), the band width in the case of microband(s), etc.). In a further preferred embodiment, the ratio of the microchannel height to the characteristic dimension of the working electrode(s) is comprised between 2 and 5. In a most preferred embodiment, the microchannel height is smaller than about 500 micrometers and the characteristic dimension of the integrated working electrode(s) is smaller than about 200 micrometers. As will be shown below, an apparatus of the present invention having integrated working electrode(s) with a diameter of 50 micrometer and a microchannel height of 60 micrometer enables one to optimise amperometric detection when the current is measured for only 2 seconds.

The above-mentioned specific features of the device of this invention also apply in the case of recessed integrated working electrode(s), provided that the recess has a height L smaller than the characteristic dimension of the electrode(s).

In one embodiment, the microstructure of the present invention is sized to contain no more than about 500 mL of solution, more preferably no more than about 200 mL and most preferably no more than about 100 mL of solution. In a further embodiment, the microstructure includes at least one integrated working electrode a wall portion of the microstructure and this electrode is a microdisc having a diameter of no more than about 100 micrometers, more preferably no more than about 50 micrometers and most preferably no more than about 25 micrometers, thereby forming a measurement zone wherein a volume of no more than about 500 pL of solution, respectively preferably no more than about 200 pL of solution and most preferably no more than about 100 pL, is probed during the amperometric detection step of an assay (which shall hence last no more than 10 seconds and most preferably no more than 2 seconds). When the microstructure contains a plurality of integrated working electrodes, each electrode forms a measurement zone wherein a volume of no more than about 500 pL of solution, respectively more preferably no more than about 200 pL of solution and most preferably no more than about 100 pL, is probed during the amperometric detection step of an assay. In such a configuration, the integrated working electrodes can be positioned along a portion of the microchannel length and separated by a distance at least equal to the diameter of the electrodes, so that the final detection signal is given by the addition of the currents measured at each individual electrode. In this manner, a larger part of the volume of solution confined within the microstructure is probed during an assay, while maintaining optimisation of the amperometric measurement by adapting the microstructure and electrode dimensions as well as the duration of the applied potential so as to ensure that the analyte molecules are always submitted to a hemispherical or spherical diffusion regime and to ensure that the consumption layer thickness remains smaller than the microchannel height above the electrode.

In a preferred embodiment, the microstructure is a covered microchannel having an inlet at one extremity and an outlet at another extremity of the channel. The inlet and/or outlet may be surrounded by a reservoir to facilitate manipulation of samples and reagents.

In another preferred embodiment, the electrode integrated within the microstructure is a series of working electrodes (interconnected or individually addressable). In many applications, the microchip of the present invention may advantageously have a reference electrode placed outside the microchannel, for instance at the inlet or at the outlet of the microchannel, but in such a manner that this reference electrode is in contact with the solution. In two-electrode systems, this reference electrode also plays the role of the counter electrode and thus constitutes a pseudo-reference electrode. In three-electrode systems, the counter electrode(s) may be integrated in a wall portion of the microstructure, so that the microstructure comprises both the working and the counter electrodes. In a preferred embodiment, the working electrode(s) face(s) the counter-electrode(s). In this configuration, the working electrode(s) is(are) for instance placed in the bottom of the microstructure (e.g. formed from an electrically conducting material placed on one side of the microstructure support), while the counter-electrode(s) is(are) placed in the top of the microstructure (e.g. formed from an electrically conducting material placed on the opposite side of the microstructure support). In another embodiment, the working electrode(s) and the counter-electrode(s) are adjacent and, when a plurality of electrodes is used, they can form an array of interdigitated electrodes alternating between working and counter-electrodes.

In another embodiment, the microchip device of the present invention also includes electrical connection pads and/or tracks, for providing electrical contact between each electrode (working, reference and/or counter electrode) and an electrical meter such as a potentiostat or a power supply.

In a further embodiment, the integrated working electrode is made of a well-defined portion of an electrical connection pad positioned on the side of the microchip support which is opposite to the microstructure, said well-defined portion being exposed to the solution at the bottom of the microstructure. The device of the present invention may advantageously comprise a series of such integrated electrodes, fabricated in a series of electrical connection pads placed along the microstructure. In another embodiment, the device of the invention may also comprise an array of interconnected integrated electrodes produced in one single electrical connection pad.

In the present invention, the electrical connection tracks or pads, as well as each electrode may be made of any electrically conductive material. In a preferred embodiment, the electrodes are made of a conducting ink (for example a carbon ink), or of a metal or metal alloy (for example gold, platinum, silver, osmium, titanium, chromium, etc.). In a further preferred embodiment, the electrical connection tracks or pads, as well as the electrodes are made of a metal such as copper coated with an electrochemically inert metal such as gold, platinum, silver or the like. In certain applications, a supplementary layer made of e.g. nickel can be added between the copper and the inert metal so as to prevent diffusion of copper into the inert metal layer, which would prevent the electrode from working properly. Otherwise, the electrical connection tracks and pads may be configured and arranged in such a manner that one or more electrodes in one or more microstructures are contacted. In a preferred embodiment, the microchip of the present invention is a printed circuit board, in which a microstructure has been fabricated.

The microchip of the present invention may also be arranged in such a manner that one extremity of the microchannel is positioned at the edge of the microchip support. In some embodiments, this extremity can be used to fill in the microchannel with sample and/or reagent(s). To this end, the other extremity of the microchannel may be connected to mechanical means enabling pumping or aspiration of the sample (as well as reagents) within the microchannel. In this configuration, the microchip support may be arranged in a tip shape, so as to facilitate uptake of a solution, a sample or a reagent into the microchannel and/or withdrawal or dispensing of a solution, a sample or a reagent from the microchannel. The microstructure may advantageously have one of its extremities positioned in the middle of the tip shape of the microstructure support so as to be adapted for uptake, withdrawal and/or dispense of a solution, a sample or a reagent from the edge of the microstructure support. The microstructure tip can also be adapted for piercing a solid material such as a membrane, a thin polymer foil or a tissue like skin, with the desired penetration, so as to enable direct uptake, withdrawal and/or dispense of a solution, a sample or a reagent.

In one embodiment, the microchip sensor of this invention can be functionalised with a chemical compound (for instance carboxy groups, N-hydroxysuccinimide or any molecule of interest) or with a biological material (for instance an enzyme, an antigen, an antibody, an affinity agent, a peptide, an oligonucleotide, DNA, DNA strains, cells, pathogens, viruses or the like). Functionalisation of the microchip may for instance be performed by immobilisation (e.g. by adsorption, physisorption, chemisorption, ionic bonding and/or covalent bonding) of at least one part of the microchannel surface and/or of the integrated electrode(s). In microchips comprising a plurality of integrated electrodes, a different chemical or a different biological material (e.g. different antibodies or antigens, different DNA strains, etc.) may be immobilized on each electrode of the series so as to enable multi-analyte testing. For some applications, the microstructure may also comprise a dried reagent. This can advantageously be used for reducing the number of steps of an assay, by direct dissolution of the dried reagent upon introduction of a sample or another solution within the microstructure.

In another embodiment, the microstructure of the sensor of this invention can be formed in a manner that at least one portion of the microstructure can receive a medium such as a fluid, a solid, a gel or a sol-gel. As an example, the microstructure can contain a membrane, a gelified liquid such as a plasticized organic phase, or beads. This medium can be functionalised (for instance by reversible or irreversible immobilisation) with one or a plurality of chemical compounds or biological materials. The medium may also be solid structures, for instance a chromatographic medium providing separation means or obstacles or restrictions modifying or preventing the passage of fluid at given locations within the microstructure.

In a particular embodiment, the sensor of this invention may also comprise an organic phase (in fluid or gelified form) in at least one portion of the microstructure, as can for instance be achieved with recessed integrated electrodes where the recess can contain an organic phase in contact with the electrodes, while the rest of the microstructure can be filled with an aqueous solution, for instance a sample solution. The incorporation of an organic phase in the microstructure of the sensor can for instance be used in many applications involving the presence of both an organic and an aqueous phase. With this feature, the sensor of this invention renders it possible to perform at a miniaturised scale analyses involving the transfer or passage of a species between an organic and an aqueous phase, for instance amperometric measurements of ion transfer reactions (that may or may not be assisted by an ionophore), or physico-chemical characterisations of compounds like permeability, solubility and/or lipophilicity assays. The sensor of this invention enables one to reduce sample volumes and to decrease the analysis time while proposing simplified manipulations and easy parallelisation, which is of great interest in diagnostics and pharmaceutical research where either numerous samples or large libraries of compounds that are often produced in small quantities have to be processed.

It is pointed out here that the microchip of the invention may also comprise reservoirs for sample, reagent(s), buffer, etc., reaction chambers or detection cells other than the electrodes (e.g. UV-VIS, fluorescence or any luminescence chambers) that can for instance be fabricated along the microchannel and arranged in a manner enabling connection to the amperometric sensor part of the device, thereby providing a second detection means. The microchip of the invention may also comprise additional elements such as reservoirs, sample preparation, pre-treatment or separation channels, injection loops or other functions that can be integrated in the microchip. All these elements can be fabricated and/or micromachined separately and combined into one complete system that can for example comprise an integrated circuit board supporting the microchannel(s) and the electrode(s) of the sensor and an instrument block supporting reservoir(s), electrical connection pin(s) or other additional element(s) of interest, both parts being placed in a manner providing precise connection and thereby enabling easy manipulation. A machined or injection moulded part comprising reservoirs and access holes permitting electrical connection of the electrodes of a microchip (e.g. a printed circuit board) can for instance be glued on the microchip support or injected using the desired mask over the support so as to encapsulate it while creating reservoirs at the channel inlet and outlet and openings over the contact pads serving to connect the electrode(s).

The microchip sensor of the invention can be produced as a disposable device that is suitable for many applications e.g. in vitro and in vivo diagnostic, industrial control, pharmaceutical research or environmental analysis where cross-contamination and/or false positive or false negative results must be avoided. The microchip sensors of the invention are also suitable for cost-effective automation of the analysis of a large number of samples as well as for a high throughput screening. In addition, the microchips of the invention allow one to reduce the volumes and quantities of valuable samples and/or reagents, and they can provide quantitative answers within very short times. Other features and advantages of the invention will also be apparent from the below detailed description of the preferred embodiments of the invention, from the example of demonstration thereof and from the claims.

From a second aspect, the present invention provides a method for performing an assay in a microchip, wherein the detection of the analyte of interest is conducted by amperometry in such a manner that a significant part of the microchannel section is depleted during the duration of the voltage application and concomitant amperometric measurement, but there is insufficient time to establish a linear diffusion regime along the microchannel. The present invention thus provides a method for amperometrically measuring the concentration of an electroactive analyte in a microsystem comprising at least one microstructure (preferably a covered microchannel or an array or network of covered microchannels) comprising at least one integrated working electrode having a characteristic length smaller than twice the microstructure height, said method being characterised in that the potential is applied to the integrated working electrode(s)—and the related current measured—during a time shorter than the ratio r²/D, where r is the characteristic dimension of the integrated working electrode and D is the diffusion coefficient of the electroactive analyte, so as to amperometrically detect only the analyte molecules present in a hemi-spherical consumption layer that has a thickness smaller than the microchannel height above the electrode(s).

In a preferred embodiment, the method of the present invention comprises the steps of: a) providing a microchip comprising at least one microstructure (preferably a covered microchannel or an array or network of covered microchannels) comprising at least one integrated working electrode in one wall portion of the microstructure; b) filling said microchip with a sample comprising an analyte of interest; c) applying the potential required to amperometrically detect said analyte during a time period shorter than the ratio r²/D and measuring the corresponding current at the working electrode(s) during this time period; and optionally d) repeating step c) after a relaxation time period longer than half of the ratio r²/D.

In another embodiment, the method of performing an assay according to the present invention further comprises integrating the current measured during step c) and d) over the second half of the measurement period so as to obtain the value of the charge Q resulting from the redox reaction at the working electrode(s) during this second half of the measurement period, and determining the presence, the amount or the concentration of the analyte of interest from the value of this charge. In a preferred embodiment, the method of the invention comprises performing amperometric detection of an analyte in a microchip by applying at the integrated working electrode(s) the potential required to reduce or oxidise the species to be amperometrically detected during a time period of less than 10 seconds and determining the presence, amount and/or concentration of the analyte of interest by considering the charge resulting from the reduction or respectively the oxidation reaction by integration of the current over no more than the last two seconds of measurement. In a most preferred embodiment, the method of the invention comprises performing amperometric detection of an analyte in a microchip by applying the required potential during only 2 seconds and determining the presence, amount or concentration of the analyte of interest by considering the charge resulting from the integration of the current measured during the last second of measurement.

In another embodiment, the method of the present invention comprises repeating the amperometric measurement at different times and determining the presence, amount or concentration of the analyte of interest from the time evolution of the charge measured during the sequential amperometric measurements. In a preferred embodiment, the method of the present invention comprises the step of determining the presence, amount or concentration of the analyte of interest by considering the slope of the time evolution of the charge determined during the various sequential amperometric measurements.

In one embodiment, the method of the invention is used to perform an assay in a microchip in which the concentration or the amount of the species to detect amperometrically at the integrated working electrode(s) varies with time (as for instance in the case of an electroactive species produced by an enzymatic reaction e.g. in conventional affinity or immunological tests, or in the case of a chemical or biological reaction leading to the amplification of a product e.g. in DNA tests). In such a case, the charge measured during a sequence of amperometric detection steps varies with time. The method of the present invention which consists in considering the slope of the time evolution of the charge deduced from the sequential amperometric measurements allows for optimised amperometric detection in a microchip. Indeed, the method of the invention is adapted to always measure the largest possible current by detecting only analyte molecules submitted to hemi-spherical or spherical diffusion and hence by generating a consumption layer that has a thickness smaller than the microstructure height above the electrode(s). The integration of this measured current over the second portion of the amperometric measurements also minimises the errors and the variability due to the capacitive current and the consideration of the slope of the time evolution of this charge (i.e. the evolution of this charge over repeated amperometric measurements) enables one not to consider the absolute values of the detected current and/or charge but only to provide a final result depending on the evolution of the signal with time and hence based on relative values of the measured current and/or charge.

With recessed electrodes, the method of using the charge deduced from the last part of the amperometric measurements also allows one not to take into account the current resulting from the depletion of the analyte molecules present in the volume of the electrode recess, but to consider only the current resulting from the flux of analyte molecules submitted to spherical or hemispherical diffusion towards the electrode. In this manner, the microsensor delivers results based on the highest diffusion flux and hence on the largest possible measurable currents, thereby providing optimised electrochemical signals and hence the highest possible sensitivity.

In a further embodiment, the present invention provides a method of performing an assay with sequential amperometric measurements, wherein the electroactive species which is reduced or oxidised during the amperometric measurement is electrochemically reversible, so that it can be regenerated. In a two-electrode system, the electroactive species can be regenerated by inverting the potential imposed at the working electrode(s) during the time interval separating two successive amperometric measurements. In a three-electrode system, the counter electrode may advantageously be placed sufficiently closed to the working electrode(s) so as to enable regeneration of the electroactive species.

In a further embodiment, the method of the invention may be adapted to simultaneously detect a plurality of analytes, for example by applying different potentials to the integrated working electrode(s) or, in a microchip sensor comprising a plurality of microstructures, by applying different potentials in the different microstructures. In some applications, the microsensor of the invention may also be functionalised with a plurality of chemical or biological compounds (such as a plurality of antibodies, antigens, proteins, DNA strains, etc.) in order to enable the performance of a plurality of tests simultaneously. Similarly to what is achieved with microarrays where small spots of biological probes are created to specifically capture analytes of interest, portions of the microstructure can be specifically functionalised (e.g. by immobilisation) with the chemical or biological compounds requested for a desired series of assays. In the same manner, each of the integrated working electrodes can be functionalised with another chemical or biological moiety so as to produce an array of capture sites, such as but not limited to a DNA, a protein or a cellular array in which each electrode is devoted to a specific test, thereby enabling parallelisation and/or multiplexing of the assays.

In a third aspect, the present invention provides a method for fabricating microchip systems comprising at least one microstructure (preferably a covered microchannel or a network or array of covered microchannels) comprising at least one integrated working electrode having a characteristic length smaller than twice the microstructure height.

The microchip of the present invention can be fabricated by any microfabrication means, such as but not limited to embossing, injection moulding, chemical etching, physical etching, such as plasma etching, laser ablation, polymer casting, UV Liga, silicon-based techniques, integration of a spacer between two material layers or any combination thereof. In a preferred embodiment, the microchip is made of a multilayer body comprising at least one layer in which the microstructure(s) is(are) fabricated (hereinafter referred to as “chip support” or “microstructure support”), electrical conducting tracks and/or pads for the connection of the electrode(s) and a second layer (for instance a lamination layer, a polymer foil or a glass slide) used to cover or seal the microstructure; in a more preferred embodiment, the microchip comprises a chip support made of a polymer material (e.g. polyethylene, polystyrene, polyethylene terephthalate, polymethylmethacrylate, polyimide, polycarbonate, polyurethane, liquid crystalline polymer or polyolefines) and the cover layer is also made of a polymer material, while the electrical conducting tracks and/or pads are made of a metal (e.g. copper, coated or not with an inert metal like gold, platinum, silver, etc.) or an electrically conductive ink such as a carbon ink which can for instance comprise silver and/or silver chloride, and which can be screen-printed on the microchip support. In one embodiment, the microstructure support may also be made of glass or quartz. In a further embodiment, the microstructure support has a thickness smaller than about 500 micrometers and most preferably smaller than about 100 micrometers. In another embodiment, the microchip comprises a plurality of microstructures (as for instance an array of microchannels or a network of microchannels, or a series of micro-wells or micro-holes).

In one embodiment, said at least one integrated working electrode is fabricated by exposing to the bottom of a microstructure a well-defined portion of an electrical connection pad positioned on the side of the microchip support which is opposite to the microstructure, said well-defined portion being thereby exposed to the solution present within the microstructure; exposure of the working electrode may for instance be achieved by eliminating material of the microchip support which is placed between the bottom of the microstructure and the electrical connection pad. For example, elimination of material from the solid support can be achieved by mechanical drilling from the bottom of the microstructure, by chemical or physical etching, by photoablation, or any other method or combination of methods.

For the use of the microchip of the invention, it may be advantageous to turn the device upside down, so that the chip support constitutes the upper part of the device, while the cover constitutes the bottom part of the device. When the conductive tracks and/or pads are positioned below the microstructure, on the opposite side of the chip support, the turning of the device upside down may advantageously facilitate access to the conductive tracks and/or pads and hence facilitate connection of the device to an external electrical meter such as a potentiostat.

The microfluidic sensor of this invention may be part of an integrated sample acquisition device and/or analyte measurement system, and can constitute the consumable part of an instrument such as an integrated robot as used for instance in diagnostics applications, pharmaceutical research or high-throughput screening platforms. On the other hand, the microfluidic sensor of this invention may be the disposable or consumable part of a portable or transportable system, as those used for field testing, point-of-care testing or self-care testing. The microfluidic sensor of this invention can also be part of a kit comprising the solution(s) and/or reagent(s) required to perform dedicated analyses.

### BRIEF DESCRIPTION OF THE DRAWINGS

The invention is further described, by way of examples only, referring to the accompanying drawings, wherein like reference numerals and letters indicate corresponding structure or feature throughout the several views and in which:

FIG. 1 is a schematic view of the hemispherical diffusion layer (3) established at a microdisc electrode (1) placed on the wall surface of a solid support (2) in a semi-infinite environment in the direction perpendicular to the microelectrode surface, in which the natural convection (4) homogenises the solution;

FIG. 2 is the conventional current versus time response obtained during an amperometric detection at a microelectrode, in which the first portion of the response shows a strong current decrease due to the capacitive current and in which the second portion of the response shows a flat profile corresponding to the steady-state current (5) resulting from the faradic current of the redox reaction taking place at the microelectrode in the environment shown in FIG. 1;

FIG. 3 is a schematic drawing of a microelectrode (6) incorporated in a wall portion of a covered microchannel (7) composed of a bottom wall (8) and of a roof (9) in which the consumption layer (10, 10′, 10″, 10′″) above the microelectrode (6) expands with time and varies from a shape corresponding to hemispherical diffusion in the direction orthogonal to the electrode surface (FIGS. 3A and 3B), to a mix between hemispherical and linear diffusion regimes (FIG. 3C), before taking a shape corresponding to linear diffusion along the microchannel length (FIG. 3D);

FIG. 4 shows the chrono-amperometric response obtained for the detection of ferrocene in an open, i.e. a non-covered, microchannel (11) and, respectively, in a covered microchannel (12), both comprising a series of 24 working microdisc electrodes integrated in the bottom wall of the microchannel;

FIG. 5 shows the chrono-amperometric response of FIG. 4 during the first ten seconds of measurement;

FIG. 6 shows the different contributions of the current measured by chrono-amperometry for the oxidation of 500 μM ferrocene in phosphate saline buffer at pH 7.4, in a microchannel of about 100 mL volume and of about 60 micrometer height comprising four microdisc working electrodes of 50 micrometer diameter; this figure illustrates that the obtained current (14) is the sum of the capacitive current (13) which rapidly decreases to a negligible value and of the faradic current (13′) resulting from the oxidation reaction at the integrated working electrodes; in the method of the present invention, the charge Q obtained by integration of the current over the time interval t₁ to t₂ (i.e. the second part of the amperometric measurement period where the capacitive current is negligible or at least approx. constant from experiments to experiments) is considered for determining the presence, the concentration or the amount of the analyte of interest in the volume surrounding the integrated working electrode(s);

FIG. 7 shows the evolution of the charge resulting from the integration of the second part of the current response obtained during sequential amperometric measurements of the oxidation of p-aminophenol produced by enzymatic reaction with alkaline phosphatase (ALP) of p-aminophenyl phosphate in a covered microchannel having an integrated microelectrode of about 50 micrometers diameter; the sequential amperometric measurements are performed for 2 seconds and repeated after a relaxation time of 50 seconds, and the entire detection is repeated three times by renewing the solution of p-aminophenyl phosphate in the microchannel (by pumping fresh solution at times tₐ₁ and tₐ₂ and switching off the pump at times t_{b1} and, respectively t_{b2}, so as to let ALP transform aminophenyl phosphate into p-aminophenol which is then detected amperometrically at various time points for 2 seconds);

FIG. 8 is a schematic view of a covered microchannel (7) having a plurality of electrodes (15, 16 and 17) separated by a distance a which corresponds to twice the thickness of the diffusion layers (18, 19 and respectively 20) of the analyte above each individual electrode which corresponds to twice the characteristic length of the working electrodes, so that the amperometric response is not dependent on the microchannel geometry but only on the electrodes geometry;

FIG. 9 is a schematic view of a covered microchannel (7) having a plurality of electrodes (15′, 16′ and 17′) in which the inter-electrode distance is such that the consumption layers (18′, 19′ and respectively 20′) above each individual electrode overlap on the time scale of the amperometric measurement, so that the amperometric response depends on both the microchannel and the electrode geometry;

FIG. 10 shows the theoretical (21) and the effective (22) evolutions of the current responses obtained by amperometric detection in a covered microchannel of a given length but with increasing numbers of integrated working microelectrodes; once the consumption layer on each individual electrode overlaps with that on the adjacent electrodes, the limiting diffusion current (i.e. the maximum detectable current) no longer increases linearly with the number of electrodes, but becomes more and more saturated;

FIG. 11 shows the evolution of the current obtained by amperometric detection of a solution of 500 μM ferrocene in phosphate saline buffer at pH 7.4, in a microchip made of a 75 micrometer thick polyimide foil comprising a 1 cm long microchannel of 1 cm in length and of about 60 micrometers in height having a semi-cylindrical shape similar to that shown in FIG. 20 below with a height of about 60 micrometers, which is sealed by lamination of a polyethylene/polyethylene terephthalate layer and which comprises a series of 6, 12, 24 or 48 gold-coated copper electrodes separated by respectively 850 μm, 350 μm, 150 μm and 50 μm;

FIG. 12 shows the evolution of the charge resulting from the integration of the second part of the current response obtained during sequential amperometric measurements of the oxidation or reduction of an electroactive analyte produced by enzymatic reaction in a microchannel, with (23) or without (24) regeneration of the analyte between two amperometric measurements;

FIG. 13 is a schematic drawing of a microchannel having a conductive part (25) placed in the roof (9) of a microchannel (7) and in contact with the solution present in this microchannel, and which is a third, counter electrode which can notably be used to decrease the ohmic resistance (or also called iR drop) during the detection of current of large intensities and/or to regenerate the analyte molecules consumed at the working electrodes (15-17) during the amperometric measurement(s);

FIG. 14 shows the evolution of the charge resulting from the integration of the second part of the current response obtained during sequential amperometric measurements of the oxidation or reduction of an electroactive species produced by enzymatic reaction in a microchannel comprising 24 integrated working electrodes of 50 micrometer diameter, with (26) or without (27) a conductive part placed in the roof of the covered microchannel and in electrolytic contact with the solution present in the microchannel;

FIG. 15 is a schematic drawing of a longitunal cross-section (A) and of a transversal cross section along axis x (B) of a microstructure having a conductive part (25) placed in the roof (9) of a microchannel (7) and in contact with the solution present in the microchannel, and which is a third, microband counter-electrode at which a hemicylindrical diffusion gradient (28) of regenerated analyte molecules is established along the length of the microchannel and which allows to feed the consumption layers (18″-20″) above the integrated microdisc working electrodes (15-17) with additional detectable analyte molecules;

FIG. 16 shows the chrono-amperometric responses expected in three-electrode mode in a covered microchannel comprising one or a series of working microdisc electrodes and where a third counter electrode is placed inside (29) and respectively outside (30) the microchannel;

FIG. 17 shows the detection of an enzymatic reaction by amperometry with (31) and without (32) a third, counter electrode placed in the microchannel;

FIG. 18 shows a schematic example of a microchip (100) of the present invention, in which a microchannel (7) is fabricated on one side of a chip support (102), said support comprising on the other side a conducting pad (103) comprising the working electrode or array of working electrodes in contact with a solution present in the microchannel, as well as a reference and/or counter electrode (104) at one of the extremities (inlet or outlet) of the microchannel and electrically conductive tracks (105) and pads (106) serving to connect the various electrodes to an external electrical meter such as a potentiostat;

FIG. 19 shows a side view of a chip similar to that illustrated in FIG. 18, in which the microchannel (7) sealed with a cover layer (9) and comprising an outlet and an inlet (109 and 109′) is fabricated in a chip support (102) comprising an electrical pad (103) made for instance of copper and supporting a series of working electrodes made for instance of a metallic layer (107) deposited on an electrically conductive pad (103) (e.g. gold plated over a copper pad), said electrodes exhibiting a recess (108) with respect to the microchannel wall;

FIG. 20 shows a schematic cross-section along axis y of the side view of microchip shown in FIG. 19, in which the microchannel (7) has a semi-cylindical shape and the integrated working electrode (107) is supported on an electrical pad (103) and exhibits a recess (108) with respect to the bottom wall of the microchannel;

FIG. 21 shows line drawings of a SEM image of a 50 μm gold microdisc electrode at the bottom of a microchannel (7) (FIG. 21A) and of a microscope photograph of a series of 50 μm gold microdisc electrodes separated by a 50 μm (FIG. 21B) at the bottom of a microchannel (7) produced in a polyimide chip support (102); the shape of the microchannel walls shown in FIG. 21 is typical of microchannels produced by an isotropic process, for instance plasma etching; in the present case, the electrodes are produced by creating a recess at the bottom of the microchannels (e.g. by laser photoablation, chemical etching or other adapted process) so as to remove the polyimide material over a copper conducting pad and by depositing gold on the exposed parts of the copper pad using an electroplating process;

FIG. 22 is a schematic drawing of a microchip (100) of the present invention which comprises an array of eight individually addressable microchannels, each of them comprising an electrical conductive support (103) supporting the integrated working electrode(s) as well as individually addressable connection pads (106) for connecting the electrodes, via connection tracks (105), to an external electrical meter such as a potentiostat;

FIG. 23 is the line drawing of a picture of a microchip device (100) of the present invention which comprises an array of eight individually addressable microchannels (7) fabricated by plasma etching in a polyimide chip support (102), each microchannel comprising an inlet (109) and an outlet (109′) at their extremities as well as a series of four gold-coated copper integrated working electrodes fabricated with individual gold-coated copper supports (103) that are interconnected via electrically conductive tracks (105) linked to conductive pads facilitating connection to an external potentiostat; the chip support (102) also comprise supplementary pads (104) located at proximity of the inlets (109) and outlets (109′) of the microchannels (7) and serving as counter or pseudo-reference electrode connected to the external world via supplementary conducting tracks (105) and pads (106);

FIG. 24 shows the results of immunological assays of alkaline phosphatase captured at various concentrations on anti-alkaline phosphatase immobilised on the walls of a microchannel upon sequential amperometric measurements of 2 seconds for which the charge (obtained from the integration of the measured current over the time period from t=1 s to t=2 s) is plotted as a function of time; the amperometric measurements are conducted simultaneously in a microchip comprising eight parallel microchannels and the enzymatic substrate solution is renewed twice in order to check repeatability of the measurements; and

FIG. 25 shows a calibration curve obtained for the detection of FSH in whole blood (prepared using 10% of FSH solutions of known concentration and 90% of blood doped with heparin to prevent coagulation) using a method of the present invention, in which the slope of the time evolution of the charged obtained for the oxidation of p-aminophenol into quinone imide during sequential amperometric measurements of 2 seconds, in a polyimide microchannel of 1 cm in length and of about 60 micrometers in height produced by plasma etching of a 75 micrometer thick polyimide foil sealed by lamination of a PE/PET layer and comprising a series of 4 gold microdisc electrodes having a diameter of 50 micrometers and a recess of about 15 micrometers.

### DETAILED DESCRIPTION OF PREFERRED EMBODIMENTS

Microelectrode in a Semi-Infinite Environment (Prior Art)

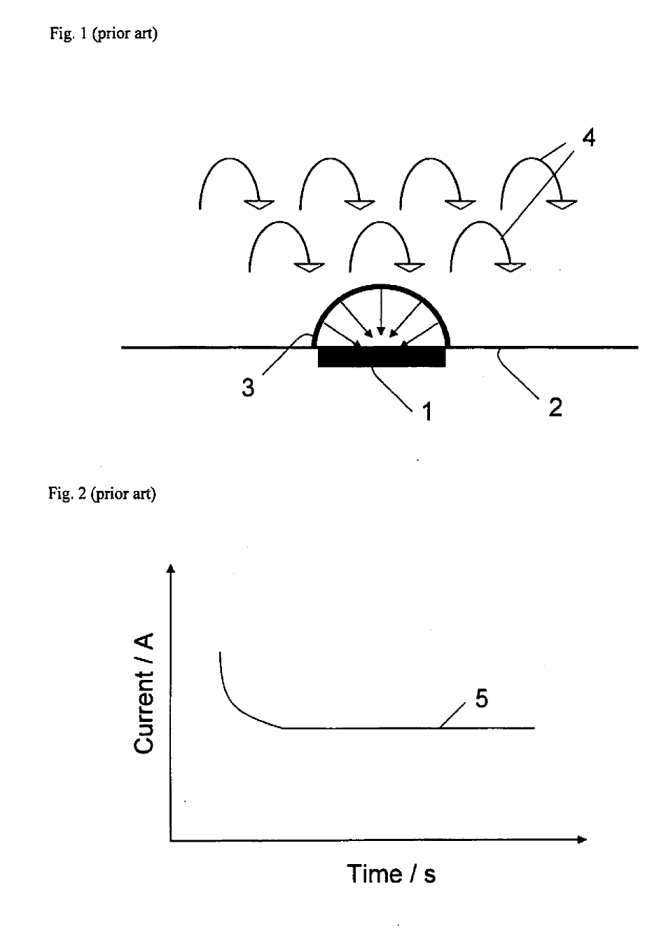

It is well known in electrochemistry that microelectrodes (1) are more sensitive than macroelectrodes because of the favorable ratio of diffusion current versus capacitive current. As schematically illustrated in FIG. 1 for a semi-infinite environment, the use of a microdisc electrode (1) placed on a solid wall surface (2) induces a hemispherical diffusion layer (3) which optimises the detection of the molecules dissolved close to the sensing area (namely the electrode surface). As illustrated in FIG. 1, the thickness of the diffusion layer (3), which has a hemispherical shape, is limited to about the radius of a circular microelectrode (see for instance H. H. Girault, Analytical and physical electrochemistry, EPFL Press, 2004, Lausanne (Switzerland), pp. 282-286 for theoretical details). In a semi-infinite plan above the diffusion layer, natural convection (4) provides a homogeneisation of the solution and therefore continuously feeds the diffusion layer (3) with a constant molecular flux. This phenomenon means that after a short equilibration time the gradient in the diffusion layer becomes constant, so that the system rapidly reaches a steady state current (and hence a constant current value) (5) which enables an easy monitoring of the concentration of the dissolved redox molecule, as exemplified in FIG. 2 by the typical shape of the chrono-amperometric response that can be obtained for such a microdisc electrode in a semi-infinite environment.

One Electrode in a Finite Environment and Limitations of the Prior Art

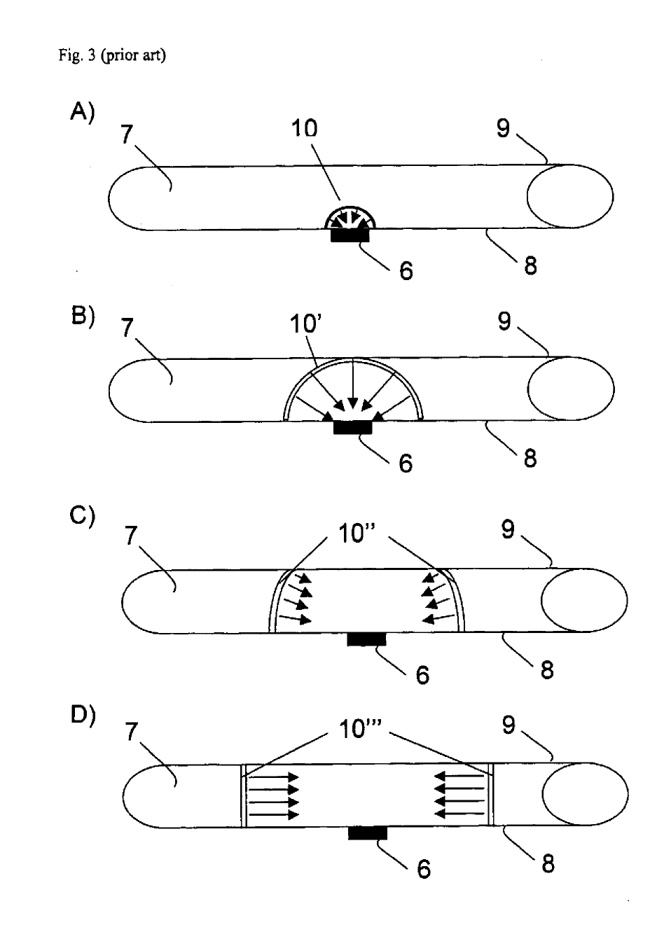

FIG. 3 shows the use of a microelectrode (6) in a microchannel (7) composed of a bottom wall (8), and a roof (9) (also hereinafter referred to as cover layer or seal) that determines a defined volume, which follows slightly different rules. Indeed, as analyte molecules are consumed during the detection, this analyte is depleted in the portion of the solution surrounding the electrode. In the absence of migration and forced convection, as is the case during the detection step in the microsensor of this invention, the depletion is controlled by the diffusion of the analyte molecules which, at a microdisc or micro-hemisphere electrode, defines a consumption layer having a hemispherical shape. However, no natural convection can organise the homogenisation of the solution and hence the creation of a diffusion layer, because the roof (9) and the microstructure walls constitute physical barriers defining a finite environment. In this case, the consumption layer does not reach a given thickness (which, in a semi-infinite environment, would correspond to the thickness of the diffusion layer), but it continuously increases with time due to the absence of natural convection. As illustrated in FIG. 3A, upon application of the potential required to oxidise or reduced the analyte of interest at the integrated microdisc electrode(s), the consumption layer first has a hemi-spherical shape corresponding to the hemi-spherical diffusion gradient around the electrode. When the consumption layer has reached the roof (9) of the microstructure (situation shown by the consumption layer 10′ in FIG. 3B), it cannot evolves further in the direction orthogonal to the electrode surface, so that it progressively changes its shape (as illustrated by the consumption layer 10″ in FIG. 3C) until it becomes only dependent on the linear diffusion along the microchannel length (see the shape of the consumption layer 10′″ in FIG. 3D). In this case, the current response does not reach a steady state, but it continuously decreases due to the second, linear regime of diffusion which applies in the direction of the channel length. The current intensity (which corresponds to the flux of redox molecules towards the electrode surface) is much smaller upon linear diffusion regime than the one that can be obtained at the same electrode upon hemi-spherical or hemi-cylindrical diffusion or in a semi-infinite environment, as e.g. in an open microchannel. Therefore, the same microsensor has an intrinsically lower sensitivity in a covered microchannel or when submitted to a linear diffusion regime than in an open microchannel or in an semi-infinite environment. The present invention thus provides a microsensor device and a detection method allowing one to optimise the current response that can be obtained, by fabricating microstructures with integrated electrode(s) having the geometrical parameters adapted to ensure the establishment of a hemi-spherical or hemi-cylindrical diffusion regime over the time scale of the detection and by defining a method of detecting only analyte molecules submitted to this hemi-cylindrical or hemi-spherical diffusion regime. In this manner, the current response in the covered microstructure of the sensor depends on the electrode shape and dimension, but is not affected by slight changes in the dimensions of the microstructure as can result from irreproducibilities in many production processes. Thus, the microsensor of this invention not only provides optimised signals compared to conventional Microsystems, but, in addition, it allows one to improve the reproducibility of the results from one microsensor to another, since our microsensor is designed to render the electrochemical response independent from e.g changes in the microstructure height above the integrated electrode(s).

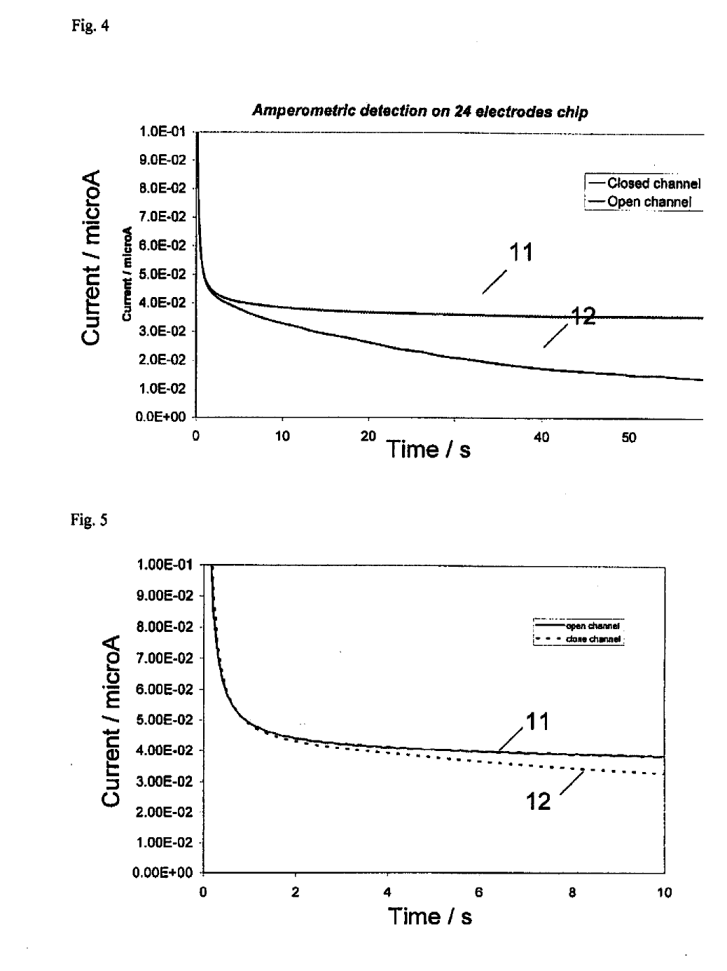

As an illustration of the effect of the diffusion regimes on the detected current, FIG. 4 shows a comparison between the amperometric response obtained with a microdisc electrode in a covered microchannel and that obtained with the same microelectrode in an open microchannel of same geometry as the covered microchannel. The amperometric response in the open microchannel (11) shows that a quasi steady-state current is obtained after a few seconds of voltage application. In contrast, the amperometric response inside the covered microchannel (12) does not reach a steady state, but shows a significant drop of the current intensity with time. This decrease of the current intensity means that the sensitivity of the assay, particularly for following long experiments, is dramatically decreased in the configuration of the covered microchannel. Furthermore, this decrease of current signifies that the diffusion regime has changed from hemispherical diffusion around the microelectrode to linear diffusion along the covered microchannel, which means that two microchannels with different depths would exhibit different current values. In this case, the current is thus directly dependent on the geometrical dimensions of the microchannel itself (and not on the electrode dimensions only), similarly to what happens in coulometric measurements.

In order to improve the sensitivity of electrochemical biosensors and in particular miniaturised amperometric sensors, it is thus necessary to have systems in which the largest values of the faradic current can be obtained (but still with low capacitive current). It would also be of great advantage to have systems in which the amperometric response does not depend on the geometrical characteristics of the reaction and/or detection locus. As exemplified above, this generally necessitates a microsystem with an open microchannel. However, open devices are only of very poor interest in analysis and cannot be envisaged as microfluidic sensors due to problems of manipulation. Such drawbacks make electrochemical systems viewed as devices of low sensitivity, which indeed hampers their development for application in high sensitivity analysis such as immunological or DNA tests, where optical systems are generally preferred. The present invention provides an amperometric microsensor that, despite being made of a covered microstructure, overcomes this limitation.

### OBJECTS OF THE INVENTION

In the present invention, we disclose amperometric microsensors in which the geometrical characteristics of the electrode(s) and the microchannel dimensions are selected in order to maximise the current response, and in which the amperometric measurement is conducted in such a way that only the analyte molecules submitted to a hemi-spherical or hemi-cylindrical diffusion regime are detected. A special amperometric detection method is also disclosed here in order to show how one can remove the capacitive current which does not give interesting information about the redox process and hence about the concentration of the analyte of interest in the solution. In this manner, the device and combined method of the present invention provide amperometric microsensors with optimium detection. These systems find many applications in various fields of biological and chemical analysis such as but not limited to immunological, oligonucleotide, DNA, cellular or enzymatic assays or physico-chemical characterisation of compounds, applications that are of particular interest for all domains of analysis such as medical diagnostics, environmental analysis, industrial control, food safety, warfare agents, water control, agriculture, etc.

It is an object of this invention to provide a microchip-based analytical system that has geometrical characteristics enabling optimum amperometric detection of an electroactive analyte, i.e. an analyte liable to reduction or oxidation reactions (redox reactions). It is another object of the present invention to provide a method of amperometrically detecting the concentration of an analyte in a covered microchannel sensor with maximum sensitivity, and it is a third object of the invention to provide a method of fabricating such amperometric microsensors.

The microsystem of the present invention comprises at least one working electrode with precise size and location inside a covered microchannel such as to enable a significant depletion of the segment of analyte solution present in the microchannel but to avoid the total depletion of the channel height, thereby remaining always with a hemi-spherical or hemi-cylindrical diffusion regime above the integrated working electrode(s) and preventing the electrochemical signal to be limited by linear diffusion along the microchannel direction.

The shape of the microsensor is chosen and the electrode(s) in the microstructure is(are) designed and located in such a way that the concentration of the electroactive analyte (namely a redox compound) is detected by an amperometric method such as to deplete the analyte in the microstructure in the first diffusion regime (namely hemi-spherical or hemi-cylindrical diffusion regime) and to prevent entering into the second, linear diffusion regime along the channel direction. In a preferred embodiment, the microstructure is a microchannel and the microchannel height is at least twice the characteristic length of the integrated working electrode(s), so that the thickness of the consumption layer remains always smaller than the microchannel height. When a plurality of analytes have to be simultaneously or consecutively detected, the microchannel height may be at least twice the thickness of the largest consumption layer, namely twice the thickness of the consumption layer corresponding to the analyte having the largest diffusion coefficient. In a further preferred embodiment, the microchannel height is just twice the characteristic length of the integrated working electrode(s), and the duration of the amperometric measurement is limited to times for which the thickness of the consumption layer remains smaller than microchannel height above the integrated working electrode(s).

In the present invention, the chrono-amperometric detection is conducted in such a manner that a significant part of the microchannel section is depleted during the duration of the voltage application and concomitant amperometric measurement, but that the linear diffusion regime along the microchannel does not have sufficient time to become established. For a compound having a diffusion coefficient D, the duration of the current measurement (or of the application of the potential required to oxidise or reduce the analyte to detect), tₐ, should be restricted to values lower than tₐ=r²/D, where r is the characteristic length of the working electrode(s).

As an example, in a 70 micrometer high microchannel comprising a circular or microdisc microelectrode having a radius of 25 micrometers in a wall portion of the microchannel, the duration of the amperometric measurement should be lower than 2.5 seconds for an analyte having a diffusion coefficient of 2.5*10⁻¹⁰ m²s⁻¹. In pure diffusion (i.e. in a purely diffusion controlled system), such a measurement time is sufficient to enable the depletion of a large part of the microchannel section and to enable the decrease of the capacitive current created upon potential application at the start of the chrono-amperometric measurement, but it is short enough to prevent a current decrease due to the change of diffusion regime (from spherical above the electrode surface to linear along the microchannel direction). In this example, the thickness of the consumption layer at the end of the amperometric measurement shall indeed be ˜50 micrometer (namely 2*(2.5*10⁻¹ m²s⁻¹*2.5 s)^{1/2}), which is smaller than the microchannel height and corresponds to about twice the characteristic length of the electrode.

FIG. 5 shows a detailed view of the chrono-amperometric response of a 50 micrometer diameter microelectrode inside either a covered microchannel of 70 micrometer diameter or inside an open microchannel having a width of 70 micrometers and infinite walls perpendicularly to the microelectrode surface. During the first two seconds after the start of the potential application, the shape of the measured current intensity is almost identical for both the covered and the open microchannel. By restricting the chrono-amperometric measurement to such short times, the current intensity is thus the largest possible since it is very similar to that obtained in an open channel (which, as mentioned above, gives the highest intensity that can theoretically be obtained).

It is thus another object of the present invention to provide a method for amperometrically measuring the concentration of an electroactive analyte in a microsystem, preferably in a covered microchannel or in an array or a network of covered microchannels, characterised in that the current is monitored during a time shorter than the ratio r²/D where r is the characteristic length of the working electrode(s) integrated in the microsystem and used for measuring the current, so as to amperometrically detect analyte molecules submitted only to a hemi-spherical or hemi-cylindrical diffusion regime and hence present in a consumption layer that has a thickness smaller than the microstructure height.

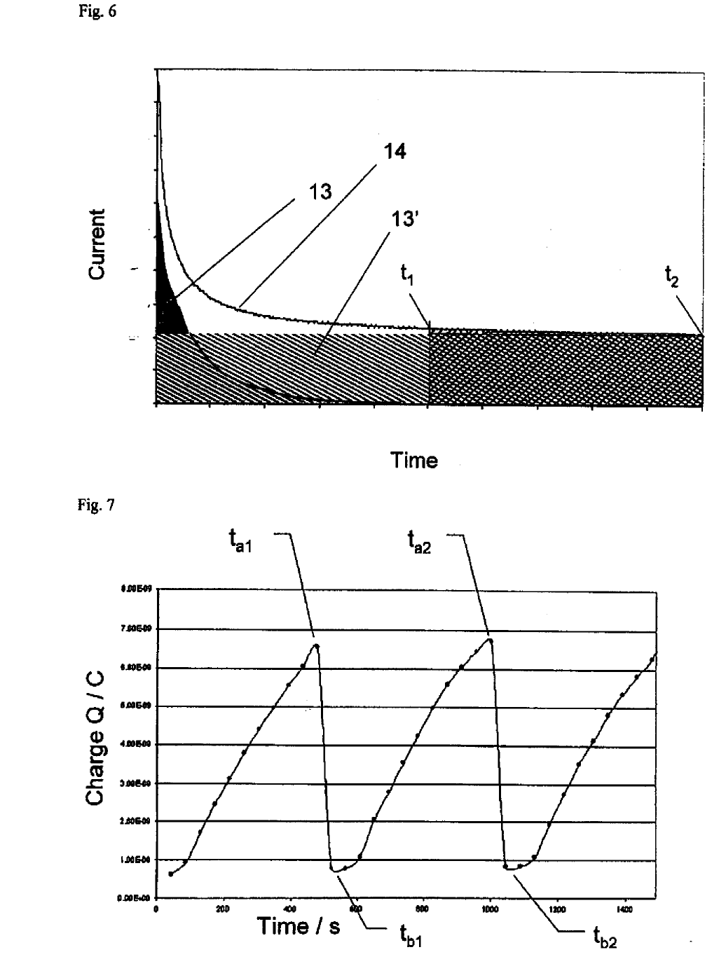

In one embodiment of the invention, the analyte concentration or amount is determined by eliminating a first measurement portion which comprises the contribution of the capacitive current and by considering the current only during the second time portion of the amperometric measurement, which relates to the faradic contribution of the measured signal and in which the capacitive current can be neglected. As illustrated in FIG. 6 which shows the chrono-amperometric current obtained for the oxidation of 500 μM ferrocene in phosphate saline buffer at pH 7.4 in a microchannel of about 100 mL volume and of about 60 micrometers in height comprising four microdisc working electrodes of about 50 micrometers in diameter, the measured current (14) is the sum of the capacitive current (13) which depends mainly on the electrode material and dimensions and on the geometry of the microsystem and of the faradic current (13′) resulting from the oxidation reaction at the integrated working electrodes and which is approximated here as a constant value over the 2 seconds of the experiment; in one embodiment of the present invention, the measurement method consists in optimising the amperometric response by considering as detection signal the current obtained during a time window in which the contribution of the capacitive current can be neglected and in which the faradic current does not decrease significantly; in this time interval, the faradic current is at the maximum measurable values, and the ratio between the faradic current and the capacitive current is also maximum. In this method of the invention, the charge Q obtained by integration of the current over the time interval t₁ to t₂ (which is thus given by the doubly hatched area in FIG. 6) is considered for determining the presence, the concentration or the amount of the analyte of interest in the volume surrounding the integrated working electrode(s). Considering this charge Q can indeed be of great advantage, because this parameter is less dependent on the variations (noise, spikes from the electrical set-up, etc.) that can affect the measured current during the experiment.

In the case where the microstructure comprises recessed integrated electrode(s), the method consisting of eliminating the first part of the measurement can advantageously be adapted to ensure that the faradic current resulting from the oxidation or reduction of the analyte molecules present in the recess(es) above the electrode(s) is also eliminated, so as to take into account as detection signal only the current from the hemispherical or hemicylindrical consumption layer established above the recess(es) and within the microstructure. The method of the invention can thus be adapted to eliminate a portion of the measured signal which corresponds to the time required by the analyte molecules comprised in the volume defined by the recess(es) above the electrode(s) to reach the electrode surface by diffusion. For example, in a microsensor having integrated working electrode(s) that is(are) recessed by 15 micrometers with respect to the microstructure surface, the first second of measurement is eliminated and not considered as detection signal with an analyte having a diffusion coefficient of 2.5*10⁻¹⁰ m²s⁻¹. In this manner, the current resulting from the redox reaction of the analyte molecules present in the recess(es) at the beginning of the measurement are not considered in the final detection result. As the amount or concentration of analyte molecules may vary in the recess(es) from one experiment to another, the present method is not affected by such changes and hence enables one to improve the reproducibility of the measurements.

In applications comprising a reaction producing and/or consuming the analyte to detect amperometrically (as for instance in applications where an enzyme produces an electroactive analyte to detect), it may be of great advantage to repeat the above chrono-amperometric measurement method several times so as to obtain the point values of the charge resulting from the redox reaction at the integrated working electrode(s) and hence determine its evolution over the time. The measurement method can thus be advantageously repeated several times at desired time intervals. Such a method may be of great advantage in assays requiring amplification as for instance in enzyme-linked immunosorbent assays (ELISA), in which the analyte concentration (namely the product of the enzymatic reaction in the example of ELISA) increases with time. In this case, the charge (obtained by the present method of integrating of the measured faradic current over the second part of sequential amperometric measurements) increases with time as a function of the rate of the enzymatic reaction, and the concentration of captured antigen or antibody may then be determined by the slope of the monitored charge versus time curve. By measuring the current resulting from the redox reaction of the analyte present only in a hemi-spherical or hemi-cylindrical consumption layer and by removing the capacitive current, the present method prevents any masking of the diffusion current by the capacitive current and enables one to increase the sensitivity of the detection. Low pM detection limit can be obtained with this detection method, while conventional detection methods have sensitivities restricted to the nanomolar or even the micromolar concentration range.

This method of the invention has also the advantage that the final detection result does not depend on the absolute value of the measured current like e.g. in end-point measurement methods, so that it is less dependent on noise and background current, which offers better repeatability. In addition, considering the current—or the corresponding charge—during sequential amperometric measurements has the advantage of enabling one to follow the evolution of the signal over time. Indeed, in assays comprising amplification of the analyte to detect as in the case of enzymatic tests or immunoassays, the evolution of the current or corresponding charge obtained during sequential amperometric measurements enables one to follow the kinetics of the enzymatic reaction, so that the detection signal does not rely on a unique value which would strongly depend on the time at which it is measured. In contrast, following the evolution of the charge with time allows one to control the signal to evolve as expected (e.g. following a Michaelis-Menten behaviour in the case of enzymatic reactions) and reduces the effect of noise as well as the errors linked to the effective starting point of the measurement. In this method of the invention, the presence, amount or concentration of an analyte can be determined by considering the slope of the curve showing the evolution of the charge over time upon successive amperometric measurements. In an immunoassay, this slope is directly proportional to the concentration of the captured analyte (e.g. an antigen or an antibody) which is revealed by a secondary antigen or antibody labelled with an enzyme which is used to transform a compound (such as, for example, p-aminophenyl phosphate) into an electroactive species (like p-aminophenol) which can then be reduced or oxidised at the integrated electrode(s) in order to be detected by amperometry. As only this slope serves as final assay signal determining the presence, concentration or amount of the analyte of interest, background signals or noise have less influence on the quality of the results, compared to what can be obtained from the currents measured at only one time point. Indeed, in some cases, the measured current in blank experiments may be larger than that obtained at low concentrations of analyte (for instance due to variations in the geometry of the individual microsensors used for the two experiments or in the size of the electrodes). However, considering the evolution of the charge over successive amperometric measurements should exhibit an increase of the signal with time even at low concentrations of analyte, whereas the obtained charge should remain constant for the blanks. A positive slope is thus obtained even at low concentrations of analyte, whereas it should remain at zero for the blanks. This method of the invention thus allows one to detect an analyte even in very small amount or concentration, and enables one to obtain very low limits of detection.

It should also be noted here that the slope obtained for blank measurements can be slightly positive in case of e.g. non-specific adsorption which gives rise to some production of the electroactive analyte, thereby inducing a signal that can disturb the sensitivity of the assay by decreasing the limit of detection. In contrast however, when the electroactive analyte to be detected at the integrated electrode(s) is not regenerated during and/or between the amperometric measurements or when it is not an electrochemically reversible compound, the concentration of the analyte decreases during the detection, thereby leading to a negative slope of the time evolution of the charge obtained from successive amperometric measurements. This phenomenon would indeed be accentuated in the case where the electroactive analyte is of poor stability and is slightly degraded on the time scale of the detection. In this manner, determining a negative slope by the method of this invention enables one to differentiate blanks (or zero calibration points) from effective measurements (that should exhibit a positive slope), thereby providing a very powerful way of optimising the limit of detection. Indeed, as soon as the slope is zero or negative, the assay result refers to the absence (or zero concentration) of the analyte of interest, whatever the error could be on this negative slope. As the measurement errors increase when approaching the limit of detection, because noise, background signals or other perturbations disturb the quality of the measurement, and as the analytical limit of detection is generally determined by the amount or concentration of analyte exhibiting an standard deviation lower than 20%, this method of the invention enables one to push this limit to a lower amount or concentration of analyte.

The method described in the two preceding paragraphs provides a very interesting way of increasing the sensitivity of an assay, and more specifically of analyses based on electrochemical detection, and thus has great interest in analytics. Combining this method with a microsystem of this invention, which is adapted to enable optimised amperometric detection, makes the present platform a very sensitive tool compared to conventional electrochemical biosensors.

FIG. 7 shows an example of the above chrono-amperometric measurement method, where a voltage is applied to a gold-coated copper electrode present in a microchannel during a given time period in order to measure the current resulting from the redox reaction of an analyte of interest. In this example, the chrono-amperometric method of the invention is used to determine the concentration of alkaline phosphatase (ALP) present in a sample. To this end, a polyimide microchip comprising a microchannel of 120 micrometer width, 60 micrometer depth and 1 cm length is first coated with anti-alkaline phosphatase (anti-ALP) and protected against non-specific adsorption by blocking with bovine serum albumin (BSA). A sample containing ALP then fills the microchannel and is incubated for 5 minutes, so as to form ALP/anti-ALP complexes. After a washing step, the complex ALP/anti-ALP is detected by filling the microchannel with p-aminophenyl phosphate (PAPP) which is used here as an enzymatic substrate. ALP transforms PAPP into p-aminophenol (PAP), which is an electroactive compound that can be oxidised into quinone imide at 200 mV vs Ag/AgCl at pH 9. Chrono-amperometric measurements can thus be carried out with this electrochemical microsystem in order to determine ALP concentration in a low amount of sample (the microchannel volume is less than 100 mL in the present example, and the detection volume above the electrode is less than 500 pL on the time scale of the amperometric detection).

In order to reach the desired sensitivity, the chrono-amperometric method of the present invention is used here as follows: the electrode inside the microchannel is polarised at 250 mV vs Ag/AgCl for 2 seconds, and the current is recorded during this time. In order to get rid of the capacitive current, only the current measured between t=1 s and t=2 s is considered in the present detection method, by taking account of the total charge Q measured during this time interval (i.e. the integral of the current measured between time t=1 s and t=2 s, and which, for simplification, can generally be estimated by the relation Q=IΔt). The concentration of ALP in the sample solution can then be easily determined by repeating the above chrono-amperometric measurement at given time intervals which allows one to determine the evolution with time of the measured charge Q and hence of the PAP concentration in the microchannel. In the present example of experiment, the time interval between two chrono-amperometric measurements, hereinafter referred to as the “relaxation time”, was fixed at 40 seconds, which allows a good homogenisation of the solution above the electrode. Indeed, as part of the PAP is oxidised during the amperometric measurement, a concentration gradient is generated around the electrode and this gradient can then be eliminated during these 40 seconds due to diffusion. For amperometric detection using a reversible redox substrate, it is also possible to recover the molecules consumed during the amperometric measurement by inverting the potential (in the present case, this would consist in setting the potential to ˜−200 mV vs Ag/AgCl during the relaxation time so as to transform the quinone imide produced during the amperometric measurement back into PAP). This measurement method thus allows one to get rid of the capacitive current, to prevent consumption of the electroactive analyte to be detected amperometrically (and/or even to renew it between two sequential measurements) and to detect only this electroactive species in a consumption layer around the electrode that has a thickness smaller than the microstructure height. This method may also be particularly advantageous in cases where the product of the redox reaction degrades or decomposes with time.

As presented in FIG. 7, the measured charge increases with time, which is in agreement with the fact that the captured ALP continuously transforms PAPP into PAP, so that the PAP concentration increases with time as well as the current resulting from its oxidation into quinone imide. In the present experiment, sequential chrono-amperometric measurements are performed over a total time period of 500 seconds, with 2 seconds of individual measurement and 40 seconds of relaxation time. After these 500 seconds (see time tₐ₁ in FIG. 7), a fresh solution of PAPP is pumped through the microchannel for renewal of the enzymatic substrate solution until time t_{b1} where the solution flow is stopped. As shown in FIG. 7, the detected charge directly falls upon renewal of the PAPP solution, before increasing again with time when there is no flow within the microchannel. This renewal of PAPP solution is repeated again after 1000 seconds of experiment (see times tₐ₂ and t_{b2} in FIG. 7), and the obtained signals clearly show that the time evolution of the detected charge is similar for the three detections.

Multi-Electrode Systems

In a further embodiment, the microstructure may comprise a plurality of electrodes. In order to obtain the highest current, these electrodes should be positioned in such a manner that the consumption layers do not overlap from one electrode to the other. In the device of the present invention, the electrodes are thus placed at a distance preventing the consumption layers above two adjacent electrodes from significant cross talk and preventing the detection from becoming a coulometric measurement. Indeed, if the detection is taking too long or if the distance between the electrodes is too small, the amperometric detection induces a total depletion of the molecules present in the microstructure. This is for instance the case in the coulometric detection system used in the FreeStyle glucose sensors of Therasense (an Abbott Laboratories company, Abbott Park, Ill., USA). In our case, we want to avoid this type of measurement, because the detection would become more dependent on the microchannel volume and would no more depend principally on the concentration of the redox molecule, as in amperometry.

In the microsensors of the invention that comprise a plurality of integrated working electrodes, the electrodes are positioned in such a manner that the distance separating each other is at least equal to the final thickness of the consumption layers at the end of the amperometric measurement. As the amperometric measurement period is fixed to times for which the final thickness of the consumption layers is about twice the characteristic length of the integrated working electrodes, the inter-electrode distance is at least twice this characteristic length. As exemplified in FIG. 8, the electrodes are thus separated by a distance a, which is larger than the final thickness of the consumption layers (18-20) above each individual electrode. In this manner, each electrode develops its own hemi-spherical consumption layer, without interference from the analyte depletion induced by the analyte consumption at the adjacent electrode(s). In this manner, the currents at each individual electrode are fully added, and the signal of the microsensor is directly proportional to the number of electrodes.

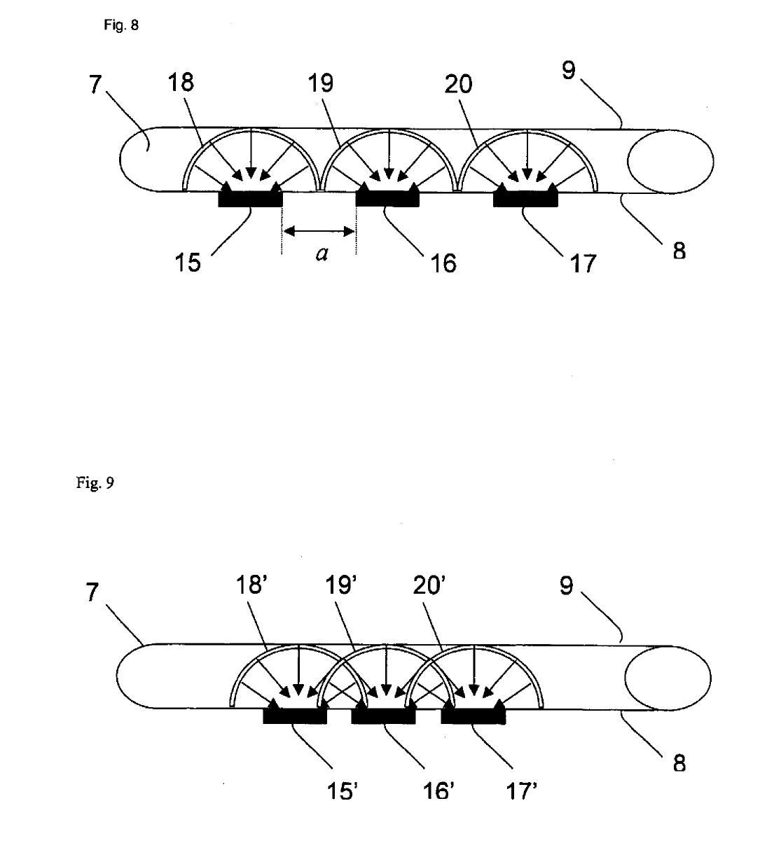

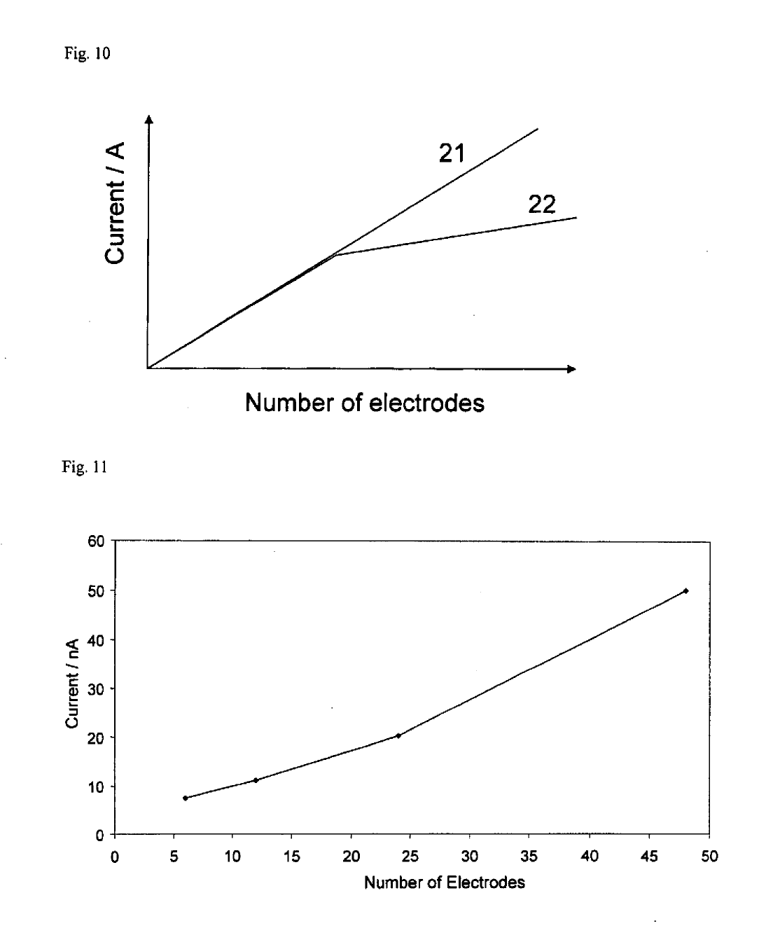

As illustrated in FIG. 9, if the detection time and the distance between the electrodes are not optimised, the consumption layers (18′-20′) above each electrode (15′-17′) overlap or are partially mixed up, so that the overall current is no longer proportional to the number of working electrodes, which results in an important loss of sensitivity. FIG. 10 shows how the total current values evolve with the number of integrated working electrodes when the distance between two adjacent electrodes remains larger than the thickness of the consumption layer (curve 21) and, respectively, when this distance becomes smaller than the consumption layer thickness beyond a certain number of integrated electrodes (curve 22). This figure illustrates that the total current is lower when the distance between the electrodes becomes too small.

It is thus an object of the present invention to provide a microfluidic amperometric sensor device having a plurality of electrodes located in such a manner that the consumption layers of each electrode do not overlap during chrono-amperometric measurements. In one embodiment of the present invention, the microchip sensor thus comprises a plurality of integrated working electrodes for which the thickness of the consumption layers is smaller than the microchannel height and smaller than the distance between two adjacent working electrodes. In this manner, optimised amperometric measurement can be obtained using the above-described method of the invention which consists in measuring the current at these electrodes during a time period sufficiently long to remove the capacitive current but sufficiently short to detect only analyte molecules submitted to hemi-spherical or hemi-cylindrical diffusion above each electrode.

In addition, with a plurality of integrated working electrodes, there is also a risk that the detection will deplete the redox molecules from the total volume of the microchannel and then become proportional to the number of analyte molecules present in the microchannel and no more, in contrast to what happens in amperometry, to the analyte concentration. This situation, that occurs in the case where the integrated working electrodes represent a large portion of the microchannel surface or, as another example, in the case where there is only one integrated electrode covering the entire length of the microchannel, has to be avoided in amperometric sensors because slight volume variations would result in different amperometric responses and would thus lead to irreproducible results.

In another embodiment, this invention also provides a detection method that enables the detection signal to increase proportionally to the number of electrodes such as for instance with a detection performed with two second time amperometric measurement in the case of electrodes of 50 micrometers in diameter separated by 100 micrometers in a microchannel of 75 micrometers in depth. As an illustration of this method of the invention, FIG. 11 shows the detection of 100 μM ferrocene in different microchannels having an increasing number of integrated working electrodes (namely 6, 12, 24 and 48 electrodes). The measured current is proportional to the number of electrodes, which shows that the method and device for the detection are optimal. If the time of the amperometric detection is too long (for instance 10 seconds), the current is no longer proportional to the number of electrodes, which leads to a loss in sensitivity.

In another embodiment, the present invention discloses a method of fabricating an amperometric microsensor comprising at least one microstructure (preferably a microchannel, or an array or network of microchannels) having a plurality of working microelectrodes integrated at precise locations in at least one wall of said microstructure and arranged in such a manner that the distance between two adjacent electrodes is at least equal to twice their characteristic length (namely to twice the radius in case of microdiscs or to twice the band width in case of band electrodes). In a preferred embodiment, the distance separating the integrated working electrodes is at least equal to twice their characteristic length, but not longer than 5 times their characteristic length. In a further preferred embodiment, the microsensor of the invention comprises a covered microchannel having a height between 10 and 250 micrometer and a series of integrated microdisc working electrodes having a diameter between 20 and 100 micrometer. In such a case, the working electrodes must be separated by a distance varying from at least 20 to 100 micrometers to a maximum between 100 and 500 micrometers.

In another embodiment, the fabrication method consists in fabricating one or a plurality of working electrode(s) in a conducting pad placed at the bottom of the microstructure (preferably one or a plurality of microchannels) on the side of the microchip support which is opposite to the groove or recess constituting the microstructure once sealed. Fabrication of the electrode(s) then comprises elimination (e.g. by chemical or physical etching, photoablation or any suitable method) of parts of the support material separating the conducting pad from the microstructure wall, thereby exposing corresponding portions of the conducting pad, said portions constituting said integrated electrode(s) which in this case exhibit(s) a recess, the height of which corresponding to the thickness of microchip support separating the bottom of the microstructure and the conducting pad. In order to create the electrodes, it can be advantageous to coat the conducting pad with e.g. an inert metal, as can for instance be achieved by electroplating.

Recycling of the Detected Analyte

In the case where the amperometric detection time is long, the detected volume is significant compared to the entire microstructure volume so that a non-negligible part of the analyte molecules is oxidised (or reduced) at the electrode(s). At the end of the amperometric detection, a significant part of the analyte molecules has thus been consumed by the redox reaction at the integrated working electrode(s), so that it is more difficult for the analyte concentration to become homogeneous again (in contrast to what happens with short amperometric detection times where only a small consumption layer over the electrode is depleted, which induces the consumption of only a very small part of the analyte molecules and hence only very slight variation of the analyte concentration within the microstructure). For certain applications, it can thus be of great advantage to regenerate the analyte molecules that have been reduced or oxidised, so as to recycle the analyte molecules that have to be detected during the next amperometric detection phase.

To this end, the analyte to detect must be a reversible or, at least, a semi-reversible redox molecule. In this manner, the product of the redox reaction occurring during the amperometric detection (namely the oxidised or the reduced analyte) can be transformed back into the analyte (by reduction or, respectively, oxidation).

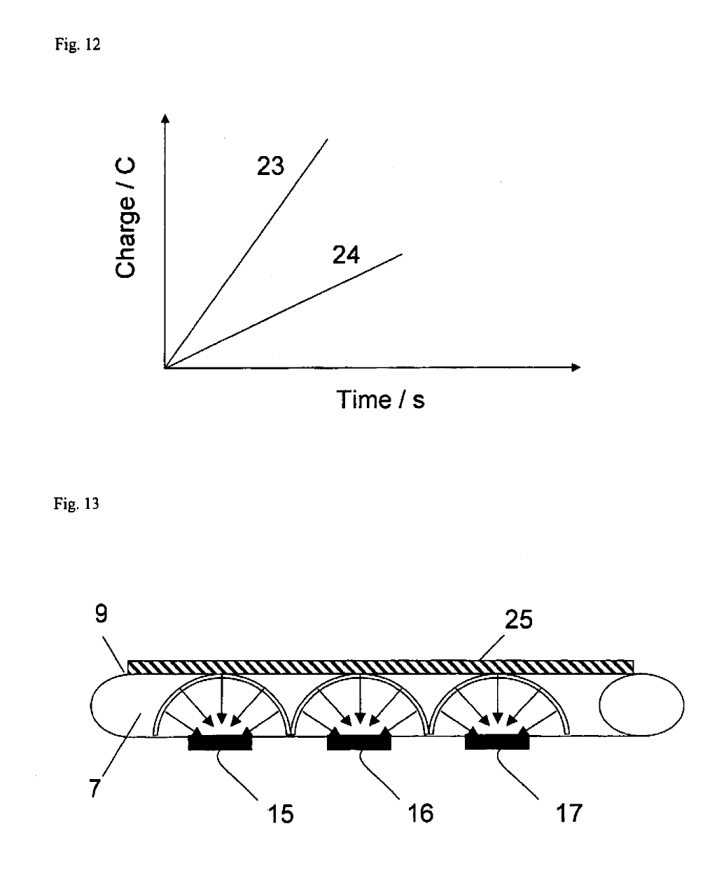

FIG. 12 shows how analyte regeneration influences the analytical response that can be obtained in systems where the analyte concentration increases with time (as is for example the case with enzymatic amplification where an enzyme continuously produces the analyte to detect). Indeed, FIG. 12 shows how the charge deduced from the amperometric current response evolves with time upon sequential amperometric measurements, with and without regeneration of the analyte between two measurements. With regeneration of the analyte, the detected current is always larger (curve 23) than without renewal (curve 24) of the analyte during the relaxation time, since the analyte concentration is then maintained at its highest possible level at the start of each amperometric measurement of the sequence.

In order to perform such a regeneration, a schematic description of a device enabling renewal or regeneration of the electroactive analyte is presented in FIG. 13. In this example, a series of working microelectrodes (15-17) is distributed on one side of a microchannel (7) so as to enable the detection by oxidation (or reduction) of analyte molecules present in the consumption layer around these electrodes. In order to enable regeneration of the oxidised (or reduced) analyte molecules, the microsensor further comprises a supplementary electrode (25) located near the working electrode(s). This electrode can either be used as a counter electrode or polarised at a potential where takes place the reaction opposite to that occurring at the working electrode(s) (namely reduction of the analyte molecules that have been previously oxidised at the working electrode(s) or, respectively, oxidation of the analyte molecules that have been previously reduced at the working electrode(s)). For simplification, the supplementary electrode (25) will be referred to as the “counter electrode” in the description below, since, when used for regeneration, it may advantageously integrate both functions of regeneration means and counter-electrode.

In some embodiments, the regeneration of the analyte molecules that have been reduced or oxidised during the detection can yet also be achieved directly by inverting the potential applied to the working electrode(s) (and hence without requiring the presence of a supplementary counter-electrode) during the relaxation time between two sequential amperometric measurements.

With the device schematically illustrated in FIG. 13, the analyte molecules that are oxidised (or reduced) at the working electrode(s) thus diffuse until they reach the counter-electrode(s) that is (are) located and configured so as to enable reduction of the diffusing oxidised analyte molecules (or oxidation of the diffusing reduced analyte molecules) and hence regeneration of the analyte.

In the example of FIG. 13, the counter-electrode is placed in front of the working electrodes, on the opposite side of the microstructure (here a microchannel), and, in order to ensure contact with the solution, it is generally covered by the roof (9) serving to seal the microstructure. Depending on the applications and on the chip fabrication process, the counter-electrode may for instance be placed on the same side as the working electrode, as for instance in inter-digitated electrode systems. When the microchip comprises a plurality of working electrodes, it may be advantageous to have a relatively large counter-electrode or to have a plurality of counter-electrodes so as to optimise the regeneration of the analyte (for instance by placing the working electrodes at equal distance of the counter-electrode(s), thereby ensuring that the species oxidised (or reduced) at each working electrode can be equally regenerated).

In order to enable efficient regeneration of the oxidised (or reduced) analyte molecules on the time scale of the experiments, the distance between the working and the counter electrodes should be sufficiently small in order to ensure that an important part of the oxidised (or reduced) analyte molecule has the time to diffuse until reaching the counter-electrode(s). In the present invention where the amperometric detection is optimised by limiting the detection duration to times where the consumption layer thickness is smaller than the microstructure height above the electrode(s), the distance between the working and the counter electrodes is thus preferably lower or sensibly equal to the microstructure height.

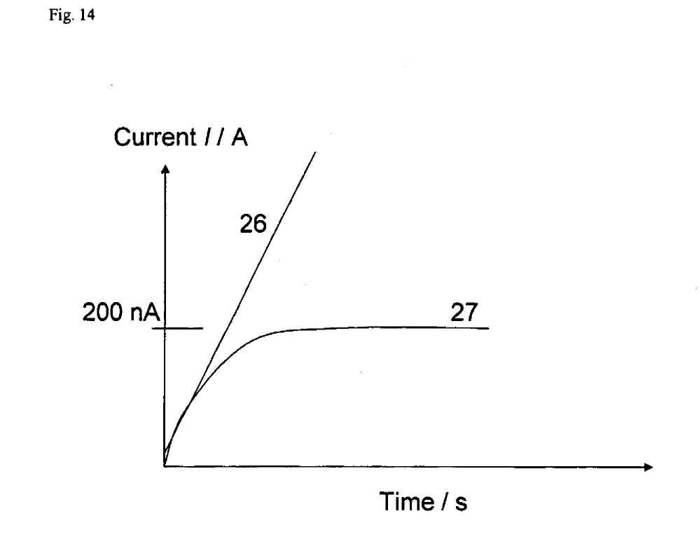

In the case of an enzymatic reaction taking place in the microstructure, the concentration of the species to be detected (namely the product of the enzymatic reaction in this case) grows with time. However, if the detection depletes the analyte in solution faster than the enzymatic reaction produces analyte molecules, the concentration to be detected will stay stagnant or even drop with time. FIG. 14 illustrates such an example, by showing (curve 27) the obtained current for a detection consuming the analyte at the speed of its enzymatic production. If regeneration is made possible, then the analyte molecules consumed at the working electrode(s) can be partially or totally regenerated, so that the concentration continues to increase as shown by the resulting current of curve 26. Indeed, the regenerated molecules will be present in the microstructure and hence be available for further detection, so that they shall add to the analyte molecules produced by the enzyme, thereby increasing the total number of detectable molecules. Integration of regeneration means thus enables one to enhance the measurable current and hence to improve the limit of detection of an assay and hence the sensibility of the present microsensor.

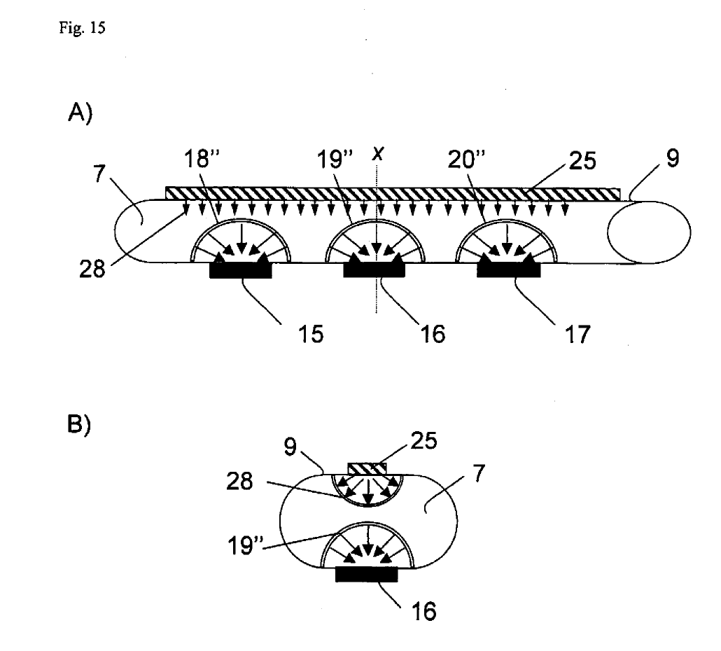

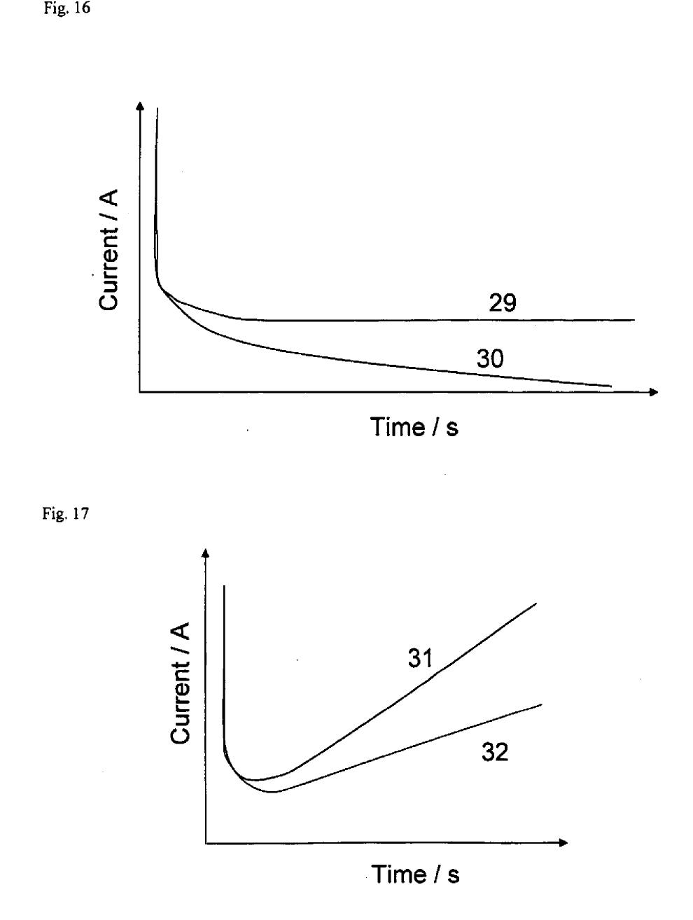

The interest of the regeneration is even better illustrated by the detection of a constant concentration of molecules when no enzymatic reaction occurs. In this case, only the molecules present in the microstructure will be depleted, and no generation of new detectable species can influence the measured current. FIG. 15 shows the evolution of the consumption layer profile in a microchannel when the counter electrode (25) is in action, with a given concentration of analyte molecules inside the microchannel. Instead of having a total depletion of the microchannel volume and to have a decrease of the analyte concentration close to the electrode, a second diffusion regime (28) occurs towards the counter electrode (25), which prevents the hemispherical consumption layers above the working microelectrodes (15-17) reaching the top of the channel. In this case, a steady state is established and a constant current is detected for a constant concentration as shown by curve 29 in FIG. 16. In the absence of a counter electrode for regenerating the oxidised (or reduced) analyte molecules, the current, as shown by curve 30 in FIG. 16, would not reach a steady-state but continuously drop because the hemispherical consumption layer would have reached the top of the channel and would further develop according to the linear diffusion regime in the direction of the channel length. The shape of the second diffusion regime (28) again depends on the shape of the counter-electrode. In the example of FIG. 15 where the counter-electrode is a thin band along the microchannel length, the diffusion regime is hemi-cylindrical, so that the analyte molecules will move essentially as fast towards the counter-electrode as towards the working electrode(s). With regeneration of the analyte molecules at an integrated counter-electrode, an equilibrium is thus established between the consumption of the analyte molecules at the working electrode(s) and the regeneration of the oxidised (or reduced) analyte molecules at the counter-electrode(s).

Finally, even with very rapid enzymatic production, it may be beneficial to have such regeneration of the detected analyte molecules due to the integrated counter electrode(s), because it enables one to optimise the number of detectable molecules within the microchannel. As illustrated in FIG. 17, the current measured at the working electrode(s) when the analyte is generated by an enzymatic reaction would indeed always be larger with than without regeneration (see curve 31 and curve 32, respectively), since the regenerated analyte molecules would add to those produced by the enzymatic reaction.

In another embodiment, the method of the invention is adapted to increase the detection signal by taking account of the current resulting from the regeneration of the detected analyte molecules in addition to that resulting from the detection, i.e. from the oxidation (or the reduction) of the electroactive analyte at the working electrode(s). Indeed, the current resulting from the regeneration of the detected analyte molecules is still indicative of the presence, amount and/or concentration of the analyte of interest within the microstructure, since this regeneration current comes from the backward part of the reversible redox reaction of the analyte of interest. As the currents resulting from both the detection and the regeneration relate to the same entity, they can both be used as detection signal. In some applications, it can even be advantageous to take into account these two signals (either by adding the absolute value of the detection and regeneration currents or by taking the difference between the detection current and that resulting from the regeneration of the oxidised or reduced analyte molecules).

To this end, amperometric detection can be achieved by first applying the potential required to oxidise (or reduce) the analyte molecules at the working electrode(s) during a period sufficiently short to probe only the analyte molecules submitted to hemispherical or hemicylindrical diffusion above the electrodes and, secondly, by applying the potential required to regenerate the analyte (i.e. the potential required to reduce (or oxidise) back the detected analyte molecules) during the same time period. Optionally, these two amperometric measurement steps can be repeated, for instance in order to follow the kinetics of an enzymatic reaction. The final detection signal can then be given by addition of the absolute values of the currents measured during the two amperometric measurement steps or by addition of the absolute value of the charge resulting from the integration of these current during the second half of these two amperometric measurements. In this manner, the signal used for determining the amount and/or concentration of the analyte of interest can be increased since it also takes into account the signal resulting from the regeneration of the electroactive molecules that have been oxidised (or reduced) at the working electrode(s) during each amperometric detection step. In the case of an electrochemically reversible analyte (for instance ferrocene, ferrocene carboxylic acid or p-aminophenol), the signal can in theory be doubled using the present method since all the detected molecules can be regenerated. Performing sequential amperometric measurements of the invention with potentials applied to the working electrode(s) alternating from a value where the analyte molecules can be oxidised (or reduced) to a value where the analyte molecules can be regenerated by reduction (or oxidisation), as can for instance be achieved with the couple p-aminophenol/quinone imide, offers a powerful means of improving the detection limit in assays requiring high sensitivity.

Fabrication of the Device

It is also an object of the invention to provide a method of fabricating electrochemical microsensors having microelectrodes integrated in a microstructure in such a manner that they enable optimised amperometric detection of one or a plurality of analytes of interest. The object is thus to fabricate an electrode or an array of electrodes or a network of electrodes in a microstructure, in such a manner that the dimension of the microstructure and of the electrode(s) as well as their respective shapes enable optimised amperometric detection. Preferably, the electrode or the array or network of electrodes has dimensions of few micrometers or smaller, and is (are) positioned at the top or bottom of the microstructure (which is preferably a microchannel or microchannel network or array).

In this invention, the microstructures (microchannel(s), access hole(s), recess(es), reservoir(s), hollow passage(s), as well as any combination thereof) can be manufactured in any support material (glass, ceramic, polymer, elastomer, etc.) by any micro-fabrication method (for instance etching, molding, embossing, ablation, mechanical drilling, UV-LIGA, (photo)-polymerisation, etc.). In the present invention, the microsensor has at least one electrode integrated in one wall of the microstructure. In a preferred embodiment, this (these) electrode(s) is (are) placed at the bottom or top of the microstructure. It (they) may be recessed or protruding with respect to the plane defined by the bottom or top of the microstructure.

In addition to the electrode integrated in one wall of the microstructure, the microstructure may comprise at least one conductive pad or one conductive track connected to the integrated electrode, so as to enable electrical connection (e.g. to a potentiostat, a wave-form generator, a power supply, etc.).

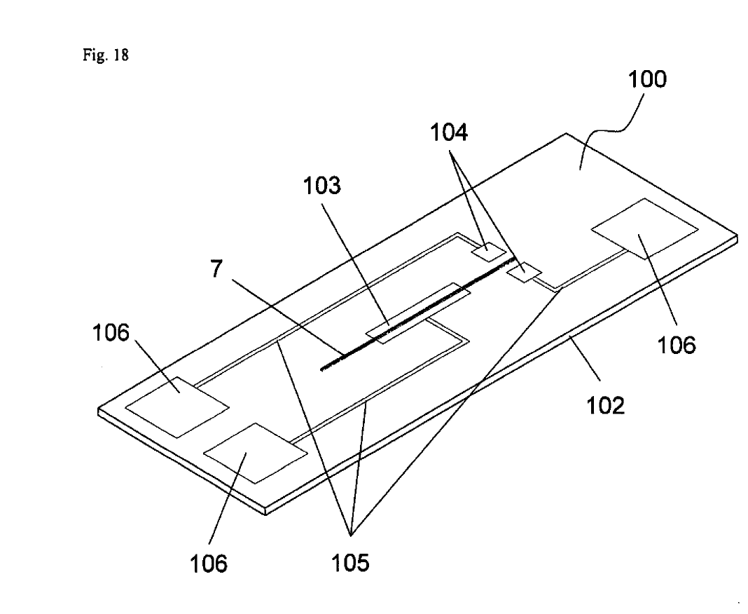

FIG. 18 shows a schematic example of a microchip (100) of the present invention, in which a microchannel (7) is fabricated on one side of a chip support (102), said support comprising on the other side a conducting pad (103) comprising the working electrode or array of working electrodes in contact with a solution present in the microchannel, as well as a reference and/or counter electrode (104) at one of the extremities (inlet or outlet) of the microchannel, and electrically conductive tracks (105) and pads (106) serving to connect the various electrodes to an external electrical meter such as a potentiostat.

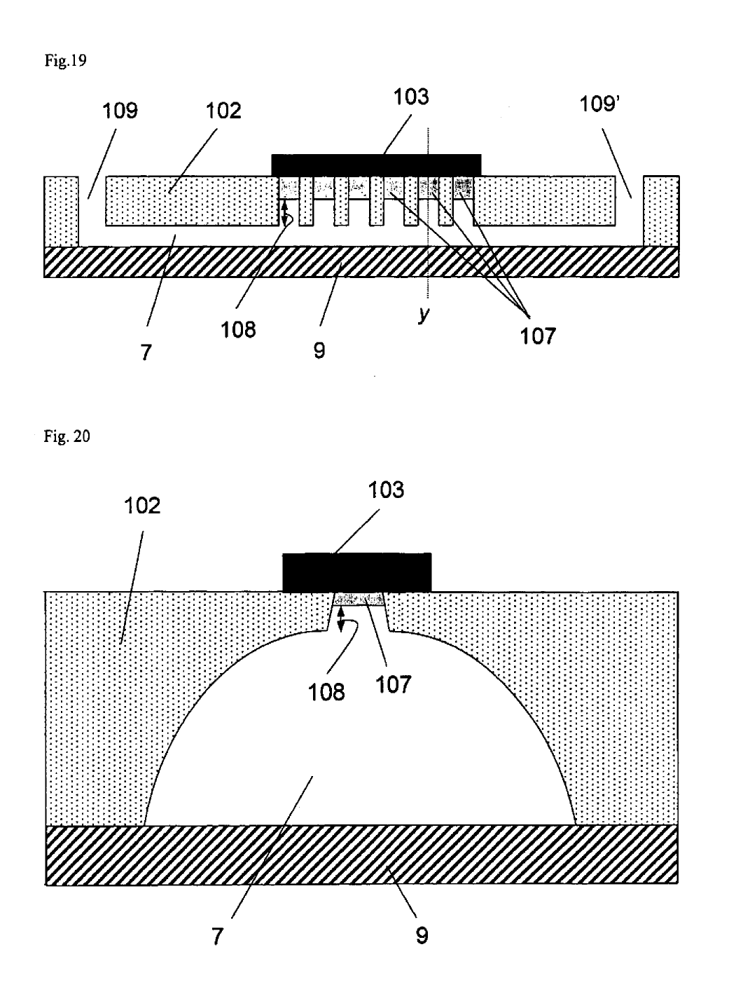

Depending on the fabrication process, the integrated electrode(s) can exhibit a recess (108) as exemplified in FIGS. 19 and 20. This feature can for instance be used to prevent an aqueous solution touching the surface of the microelectrode(s) during a part of an assay (for instance during the coating of the microstructure with antigens, antibodies, oligonucleotides, DNA, cells, etc.), until a detergent enables the wetting of the electrode surface. This can advantageously be used to avoid fouling of the electrode surface by some component of the solutions prior to the detection step(s) for instance.

In another embodiment, the recess above the integrated electrode(s) may be filled with a conductive material (for instance a plated metal) so as to prevent a bubble to be trapped in an angle of the recessed electrode(s). This procedure can also enable one to enhance the current by favouring pure hemispherical diffusion around the electrode and removing the linear diffusion along the recess.

In a further embodiment, the wall of the recess(es) can be machined in order to exhibit a funnel shape, so as to enhance the diffusion of molecules from the side of the integrated microelectrode(s). This can be performed by fabricating recesses using a trepan ablation mode which enables one to modify the angle between the microelectrode surface and the recess walls, thereby providing recess(es) having e.g. a conical shape. In some embodiment, this can be done by trepan mode laser machining or by post-processing with a further etching step that destroys the sharp angles to render them smoother. In some embodiments, this feature can be advantageously used to favour the wettability of the recess(es) and facilitate the filling of the recess(es) and hence the contact of the entire electrode(s) with the solution present in the microstructure.

In order to enable the handling and the connection of such a microfluidic sensor device, the system can be fabricated with various supports that have to be made of electrically insulating material, such as but not limited to polymer, ceramic, glass or the like. In some embodiments, as illustrated in FIG. 18, the microchip device of the invention (100) may be fabricated in a support (102), preferably made of a polymer foil or of an assembly of polymer layers, which comprises at least one microstructure (in the present case a microchannel (7) which is fabricated on one side of the chip support (102), said support comprising on the other side at least one conducting pad (103) comprising a working electrode or an array of working electrodes designed to be in contact with a solution when present in the microchannel. The chip support (102) further comprises a reference and/or counter electrode (104) at one of the extremities (inlet or outlet) of the microchannel and electrically conductive tracks (105) and pads (106) serving to connect the various electrodes to an external electrical meter like a potentiostat. The conducting pad comprising the working electrodes (103) can be made of the same material(s) as the conductive tracks (105) and pads (106). In some embodiments, conducting pads similar to that or those used to support the working electrode(s) can be fabricated in order to support the reference and/or counter electrode(s), which may facilitate integration in a wall portion of the microstructure.

As schematically illustrated in FIG. 19 by a cross-section of the device of FIG. 18 along the microchannel length, the conducting pad(s) (103) supporting the working electrode(s) can be plated, coated or covered with a coating agent (107) adapted to electrochemical detection, such as another metallic layer, a conductive ink or a conductive organic solvent for instance. In a preferred embodiment, the conducting pad(s) (103) supporting the working electrode(s) as well as the conducting tracks (105) and pads (106) are made of copper, and the coating agent (107) is gold which is coated (e.g. by electroplating) on all exposed copper surfaces and hence not only on the conducting pads (103) supporting the working electrodes but also on the conducting tracks (105) and pads (106), thereby providing gold-coated copper electrode(s). In a further preferred embodiment, the reference electrode (104) is further partially or totally coated with silver or silver/silver chloride (e.g. by deposition of a dot of a silver/silver chloride ink).

As illustrated in FIG. 19, the microstructure may be fabricated in a substrate (102) which also comprises access holes (109 and 109′) serving as microchannel inlet and outlet. In this example, these inlet and outlet are produced by fabricating holes going through the entire thickness of the chip support (102); the layer (9) serving to cover the microchannel also enables to close one extremity of these through-holes, thereby creating accesses to the microchannel than can be used for fluid dispense and/or withdrawal. In some embodiments, the microchannel inlet and/or outlet may be advantageously surrounded by a reservoir, so as to facilitate sample deposition/withdrawal and fluidic manipulations.

The microstructures of the device of this invention are not limited in shape, and they can exhibit straight walls as would result from an anisotropic fabrication process like e.g. laser ablation, embossing or injection moulding. Similarly, as schematically presented in FIG. 20 which shows a cross-section of the microchip along the axis y in FIG. 19, the microstructure may also exhibit a kind of semi-circular form as would for instance result from an isotropic microfabrication process, such as for instance a plasma etching or a wet etching process.

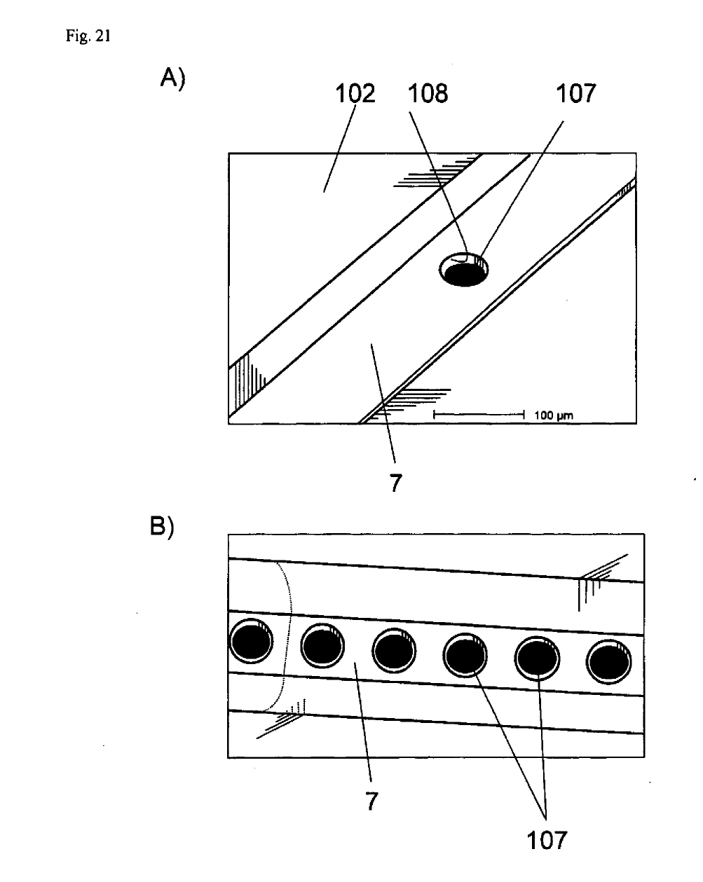

FIG. 21 provides examples of microelectrodes integrated in microchip devices of the present invention, before covering of the microstructure. In these examples, the chip support (102) is a 75 micrometer thick polyimide foil in which a groove has been fabricated using a plasma etching process to form an open microchannel (7) having a width of ˜100 microns and a height of ˜50 microns. The line drawing of FIG. 21A which mirrors a scanning electron microscope image shows that a microelectrode of 50 micrometers in diameter is integrated at the bottom of the microchannel, the visible portion of the electrode being a gold plated surface (107). The line drawing of FIG. 21B which mirrors a microscope picture presents a similar chip device in which an array of microelectrodes has been integrated. In this case, the electrodes have a diameter of 50 micrometers and are separated by a distance of 50 micrometers. These open microchannels have a semi-cylindrical shape, which is typical of an isotropic etching fabrication process. If desired, other microfabrication techniques such as injection moulding, embossing, addition of layers separated by spacer(s), etc. can lead to microstructures with straight walls and presenting larger aspect ratio.

The integration of a plurality of microelectrodes as shown in FIG. 21B may be of great advantage to increase the sensitivity of the sensor. In addition, such a device particularly benefits from the short-time amperometric detection methods of this invention, since the consumption layers do not overlap on the time scale of the detection, thereby allowing one to create the largest possible gradient of analyte concentration around the electrodes, which induces the largest possible flux of analyte molecules towards the electrodes and hence the largest possible currents. In such a configuration, the intrinsic sensitivity of each individual electrode is made for short-time amperometric detection, since the volume depleted above each electrode during the detection is lower than that defined by the microstructure height, so that a maximum number of analyte molecules remains available for each electrode on the timescale of the detection.

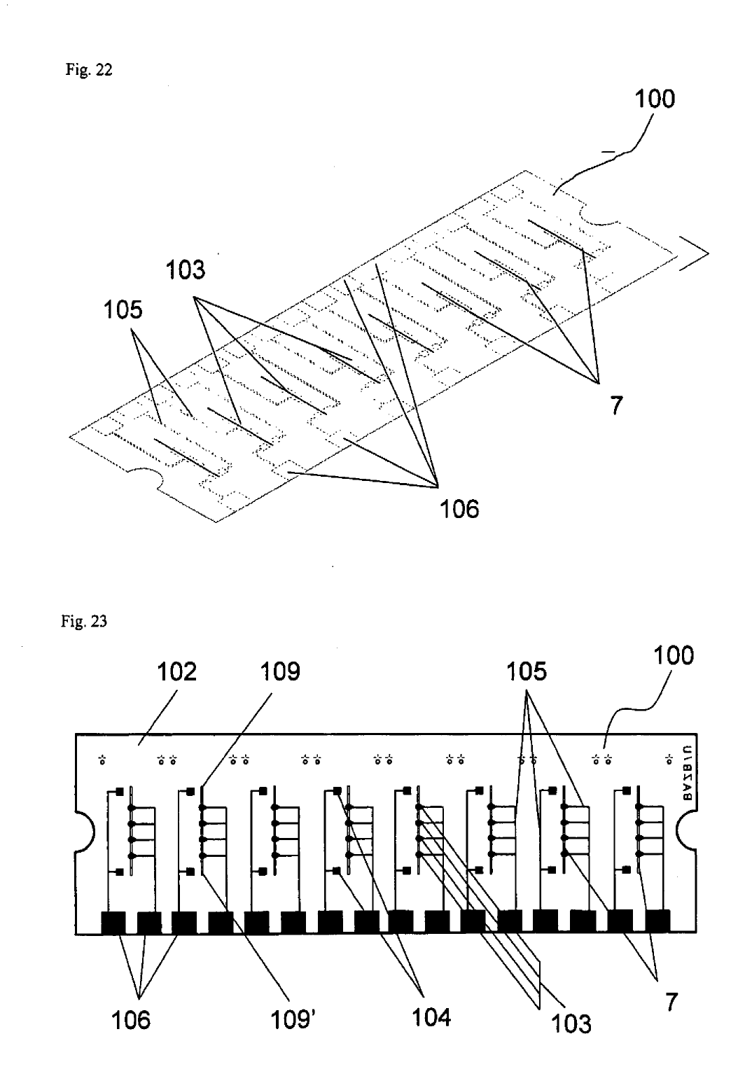

For many applications, it can be advantageous to have an electrochemical microchip sensor enabling to perform a plurality of analyses. To this end, arrays of amperometric devices of the present invention can be produced in the same chip support, and FIG. 22 shows a schematic illustration of such a chip (100) which comprises an array of an arbitrary number (eight) parallel microchannels.

Demonstration of the Invention

In order to demonstrate several embodiments of the invention, various amperometric microchip sensors have been designed and fabricated, and the methods of performing optimised amperometric measurements with these devices have also been implemented. In order to illustrate the invention, examples of devices, detection methods and results of various analyses are described below.

Description of the Microchip

As schematically illustrated in FIG. 22, examples of electrochemical microchip sensors (100) used to demonstrate how analysis can be performed with optimised amperometric detection consist in arrays of eight individually addressable microchannels (7). In the present example, the microchannels consist of grooves fabricated by means of plasma etching in a 75 or 100 μm thick polyimide substrate serving as microchip support. Each microchannel constitutes an amperometric sensor according to the present invention and comprises an inlet and an outlet at both extremities of a linear groove having the following approximate dimensions: 60-70 μm in depth, 120 μm in width and 1 cm in length. Once covered, these dimensions thus define microchannel(s) having a height of 60-70 micrometers, and the integrated electrode(s) then exhibit a recess of 5-15 micrometers with a 75 μm thick polyimide support and of 30-40 micrometers with a 100 μm thick polyimide support.

In the present case, the microstructures (namely here the grooves, the inlets and outlets) are produced by providing a multilayer body made of a polyimide substrate (serving as chip support) covered on both sides with a copper layer in which a mask having the pattern corresponding to the desired geometries and shapes of the final grooves and inlets/outlets is fabricated by: a) patterning a photoresist on the copper layers; b) eliminating this photoresist by light exposure at the places corresponding to the desired mask so as to expose the corresponding copper portions; c) eliminating the exposed copper portions by a wet etching process so as to expose the polyimide portions corresponding to the desired pattern; and, optionally, d) eliminating the remaining photoresist. This mask can then be used to etch the desired microstructure in the polymer support by chemical or physical etching in wet or, respectively, plasma etching processes. In the present case, the polyimide body with its copper mask is placed in a plasma oven (plasma of oxygen, nitrogen, argon, CF₄ or any combination thereof may for instance be used depending on the material to etch and on the physicochemical properties desired for the etched surfaces). The plasma attacks the exposed portions of the substrate, thereby creating the desired microstructures. In a second step, the conducting tracks (105) and pads (106) are fabricated by elimination of the undesired copper. Then, microelectrodes are integrated at the bottom of the microchannel by eliminating small, well-defined and well-located portions of the chip support material so as to expose the desired part of the copper pad(s) (103) serving to support the electrodes. A second plasma etching step similar to that described above or, as in the examples used for the demonstration of the invention, laser photoablation can for instance be used to create the microelectrodes. As copper is not well suited for electrochemical detection purposes, the copper surfaces are further coated with an inert metal such as gold using e.g. an electroplating process, thereby providing integrated electrodes made of gold-coated copper, as well as gold-coated copper conducting tracks (105) and pads (106), part of which are able to be used as reference and/or counter electrodes placed outside the microstructure but in contact with the analyte solution at the inlet and/or outlet of the microstructures. In the present case, the reference electrode is made by depositing a dot of Ag/AgCl ink on the connection track at the outlet of the microstructure, as schematically illustrated in detail with the reference electrode (104) shown in FIG. 18. As a final production step, the microstructured grooves are covered, for instance by laminating a plastic layer made of e.g. polyethlyene/polyethylene terephthalate, thereby forming sealed microchannels that enable microfluidic manipulations.

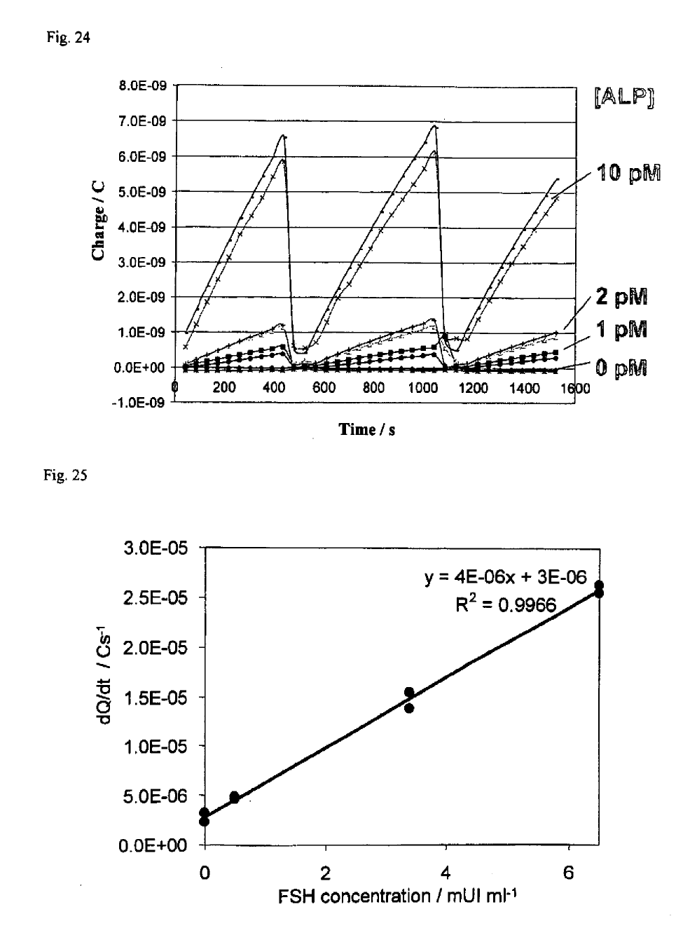

The microchip devices produced for the present demonstration examples comprise various numbers of integrated working micro-electrodes. In the configuration shown in FIG. 23 which mirrors a photograph of the chips used to perform the assays presented below in FIGS. 24 and 25, the microchannels incorporate a series of four working microelectrodes that are supported on individual gold-coated copper supports (103) that are interconnected via gold-coated copper tracks (105) and via pads (106) placed close to the edge of the chip support for connection to an external potentiostat. These electrodes have a diameter of 50 micrometers and are separated by ˜2 mm. Counter and/or pseudo-reference electrodes (104) are fabricated at proximity of the microchannel inlets and outlets so as to ensure contact with the analyte solution that is generally placed in a supplementary reservoir surrounding the microchannel inlets. In such a microchip device, the thickness of the consumption layer above the electrodes is slightly smaller than the microchannel height, so that optimised detection can be obtained from the fast amperometric detection methods of the invention that enable one to detect only the analyte molecules submitted to hemispherical or hemi-cylindrical diffusion above each electrode.

In another chip configuration, the integrated working microelectrodes are supported by a single pad, in which up to 72 electrodes have been produced. For the assay results presented below for TSH assays with or without regeneration of the analyte, the microchannels comprise 48 working microelectrodes of ˜50 μm diameter that are separated by a distance of 50 micrometers, thereby providing a microfluidic device having, on the timescale of the detection, a maximum consumption layer thickness above the electrodes substantially equal to the microchannel height and to the inter-electrode distance.

For performing the assays, the 8-microchannel array chip is connected to a potentiostat by way of a holder providing sixteen contact points (for one working and one pseudo-reference electrodes per microchannel) through springs, as well as eight fluidic connections at the outlet of the microchannels. Each individual channel is connected by soft tubing to a multi-peristaltic pump (IPC-N-8 model, Ismatec, Switzerland) through the microfluidic connections of the holder, and each electrode is connected to a multi-potentiostat (Palmsens, Netherlands) thank to a multiplexing box that enables one to switch the port of the potentiostat so as to provide sequential measurement in each microchannel (see the section below about detection). At the other extremity of the microchannels, a polystyrene reservoir is glued on the polyimide chip substrate so as to enable the dispensing of solutions (samples, reagents, washing solution or other) having a volume of up to 50 μL. In this reservoir, a silver/silver choloride (Ag/AgCl) ink dot is deposited on the electrical pads at the bottom of the inlet reservoirs so as to provide pseudo-reference electrodes that can always be in contact with the solution(s) to analyse.

The microfluidic handling is performed by aspiration of the solutions from the reservoirs into the microchannels and then towards a waste placed after the peristaltic pump. The indicative flow rates are set at 0.4 or 1 μL/min but it must be remarked here that with a peristaltic pump the linear velocity of the solution is not constant due to the inherent pulses induced by the rollers of the pump.

Chip Functionalisation for Immunoassays

In order to demonstrate examples of applications of the microchip devices and methods of the invention, immunological assays have been performed. To this end, two procedures have been used for the immobilisation of the antibodies in the microchip. First, simple physisorption has been used to immobilise antibodies in a first series of microchips. Anti-phosphatase (anti-ALP) antibodies have for instance been diluted to a concentration of 10 μg/mL and placed in the reservoirs of eight microchannel chips before being pumped through the microchannels at a flow rate of 0.4 μL/min for 1 hour at room temperature. In a parallel experiment, the chips were previously acidified to generate carboxylic groups on the surface of the polymer microchannels; then, N-hydroxysuccinimide was added so as to form activated groups enabling to covalently link the antibodies.

After these two different immobilisation procedures, the chips were blocked with a % bovine serum albumin (BSA) solution diluted in 0.1% Tween 20, which was again pumped through the microchannels during 30 minutes at 0.4 μl min-1. The chips were then washed with water and dried in air prior to the assay.

Assay Procedure and Amperometric Detection

A solution of alkaline phosphatase (ALP) was pumped at different concentrations and different durations in order to assess the limit of detection that can be obtained with the microchip devices and amperometric detection methods of the invention. After incubation of this phosphatase sample solution at room temperature, the excess solution in the reservoir was withdrawn, and the microchannels were washed again. A solution of substrate of the alkaline phosphatase (namely, in the present case, p-aminophenyl phosphate (PAPP) in tri-ethanol amine (TEA) buffer at pH 9) was then placed in the reservoirs and introduced inside the eight microchannels of the chip device in parallel thanks to the multi-peristaltic pump. This substrate solution was then incubated for a few seconds under static conditions (no solution flow) so as to let PAPP be hydrolysed into p-aminophenol (PAP) by the ALP molecules that were captured on the immobilised anti-ALP antibodies. Detection of p-aminophenol can then be performed by imposing a potential difference of 250 mV vs Ag/AgCl between the working and the reference electrodes in order to oxidise PAP into quinone imide. Sequential amperometric detections can also be performed by renewing the microchannels with fresh substrate solution. To this end, a desired amount of substrate solution can be flushed through the microchannels for 2 s, and the pump is then stopped during the detection.

In the present invention, chrono-amperometric detections can be performed in such a manner that, for instance, the kinetics of an enzymatic reaction can be followed, i.e. by measuring, as a function of time, the increase of the analyte concentration (i.e. here the concentration of the product of the enzymatic reaction which is directly linked to the amount of captured ALP molecules, thereby providing the information searched for in the assay). Otherwise, during the chrono-amperometric detection step, the product of the enzymatic reaction is constantly consumed by the oxidation reaction at the working electrode(s), so that its concentration (and hence the measured current) raises less rapidly. In order to optimise the amperometric response, chrono-amperometric detection steps of short duration have been performed by application of the voltage for only two seconds and measuring the current during this time period. Then, a relaxation time of 40 seconds has been set in order to let the enzymatic reaction increase the analyte concentration, before performing again an amperometric measurement for two seconds, and repeating these operations for 5 to 10 minutes, so as to obtain the time evolution of the detected current and hence of the analyte concentration which is here the product of the enzymatic reaction.

As the capacitive current (which has no informative value for experiments such as enzymatic assays or immunological tests) sharply decreases during the first second of potential application and in order to get rid of the signal resulting from the detection of the analyte molecules present in the volume of the recesses above the electrodes at the beginning of the detection, only the current measured between t=1 s and t=2 s of the chrono-amperometric measurements is considered as a detection signal, and this signal is integrated over this time interval so as to obtain the resulting charge which is then plotted against the time for each microchannel and for the successive amperometric measurements. At the end of the detection, eight current-vs-time plots are obtained for the eight assays. The slope at the origin of the plotted curves directly reveals the enzymatic activity inside the respective microchannel, and hence the number of ALP molecules that have been captured on the anti-ALP antibodies immobilised on the walls of these microchannels. This procedure also enables the detection to be less sensitive to partially hydrolysed enzymatic substrate (namely non-desired analyte) because only the difference of p-aminophenol concentration between two measurement points (and not the absolute value of this PAP concentration) is taken into account in the measurement method of this invention.

An example of such a detection is presented in FIG. 24, where 8 parallel assays and detections are performed using a device such as the one shown in FIG. 23. Alkaline phosphatase at four different concentrations (namely 0, 1, 2 and 10 μM) was incubated in the eight microchannel chip (two channels are used per concentration). The detection is then performed as described above and for 450 s a first sequence of amperometric detections of 2 seconds is performed with fresh substrate and the charge resulting from the current detected between t=1 s and t=2 s in each individual channel is reported as a function of time for each microchannel. After 450 seconds, the microchannels are filled again with fresh substrate, the ALP enzymes being still bound to the antibodies immobilised on the channel walls. Then, the enzymatic reaction is followed again by amperometric detection. It should be mentioned here that the amperometric detection is made only every 40 s in the various microchannels, thereby enabling the enzymatic reaction to produce and increase the concentration of molecules to be detected at the integrated working microelectrodes. After these 40 seconds of relaxation time, the electrodes are polarised during only 2 seconds during which the oxidation of the product of the enzymatic reaction takes place. The current values after removal of the capacitive current are then integrated over the time interval t=1 s to t=2 s, and the resulting charge is reported as a function of the time of the successive amperometric measurements. As can be deduced from FIG. 24, the full detection procedure has been performed 3 times in this example, and the effective ALP concentration in the various microchannels can be easily deduced from the slopes at the origin of each of these three repetitive detection sequences.

In order to demonstrate the use of the devices and methods of this invention in clinical analysis like in vitro diagnostics, a similar experiment has been performed in 8-channel chips similar to that shown in FIG. 23 for detecting follicular stimulating hormone (FSH) in whole blood. The microchip sensors have been coated with anti-FSH antibodies, and blood samples with four different concentrations have been injected in the different channels. Then, the sample solution has been removed, and a solution of FSH antibody conjugated with the enzyme alkaline phosphatase has been injected in the various channels, so as to form a complex with the FSH molecules that have been previously captured on the anti-FSH antibodies immobilised on the microchannel walls. The microchannels have then been washed with buffer, before being filled again with a solution of PAPP as enzymatic substrate which produces PAP which can be detected by amperometry. The same amperometric measurement method as that used for obtaining the results presented in FIG. 24 allows one to show that it is possible to detect small concentrations of the FSH molecules which were present in the blood samples, as illustrated in FIG. 25 which shows the values of the slopes at the origin obtained from the charge-versus-time curves as a function of the effective FSH concentration in the various samples.

In order to show the signal that can be expected when a counter-electrode is integrated in the microchannel, a microchip sensor device incorporating such a counter-electrode in a wall portion of the microchannel has been fabricated in polyimide foils by plasma etching. As a demonstration of the role of the counter electrode for the regeneration of the detected analyte, two immunoassay experiments have been run for the detection of thyroid stimulating hormone (TSH) at a known concentration of 56.1 uUI/mL in plasma: one using the chip of FIGS. 19 and 20 comprising a series of 48 integrated working electrodes and having only a pseudo reference electrode at the outlet of the microchannel; and a second one using a microchip sensor that further incorporates a counter-electrode along the microchannel length. In order to determine the TSH concentration by enzyme-linked immunosorbent assay (Elisa) in plasma samples, the microchannels were first coated with anti-TSH and blocked against non-specific adsorption using a calf serum solution. After incubation of the TSH samples, the microchannels were filled with a solution of anti-TSH conjugate labelled with ALP. Detection was then performed with PAPP as enzymatic substrate using the same amperometric method as that described above in relation with the results shown in FIG. 25. By reporting the charge resulting from the integration of the measured current over the time interval t=1 s to t=2 s of 2-second amperometric measurements as a function of the time during sequential amperometric measurements separated by 30 seconds of relaxation time, it can clearly be demonstrated (results not shown) that, without counter-electrode, the current and hence the charge reaches a plateau level, meaning that a combination between depletion of the product of the enzymatic reaction and resistance along the microchannel (iR drop) limits the signal increase. In the case of the chips with an integrated counter electrode, the measured charge is not limited and continuously increases during the sequential amperometric measurements, showing that at least part of the oxidised product (namely quinone imide in the present case) is regenerated into PAP.

Other experiments have also been conducted using liquid crystal polymer (LCP) as material for the chip support. With foils of this material having a thickness of 50 micrometer, the height of the microchannels has been reduced to 40 μm, while the electrode radius has been maintained to ˜25 μm. This feature allowed the study of the electrochemical response in microsensors having a different channel geometry as what has been presented above. Under equivalent immunoassay conditions and same 2-second amperometric detection sequences, higher currents could be generated in these small channels compared to those obtained with larger ones, due to the higher surface-to-volume ratio. Taking this change of dimension into consideration, the assay performances are thus similar for both LCP and polyimide, and LCP thus provides an alternative material for performing amperometric assays using the devices of the present invention.

The present invention has been described with reference to various specific and preferred embodiments and techniques. However, it will be apparent to ordinarily skilled people in the art that modifications may be made while remaining within the scope of the invention as defined by the appended claims.

1: An amperometric detection method for determining the presence, the amount and/or the concentration of an analyte in a microfluidic sensor comprising the steps of:
a) providing a microfluidic sensor comprising at least one microstructure including at least one working electrode integrated with precise size and location in one wall portion of said microstructure, the height of said microstructure above said integrated working electrode being at least twice the characteristic length—or the radius in the case of a circular electrode—r of said integrated working electrode;
b) filling said microfluidic sensor with the sample to analyse;
c) applying the potential required to directly or indirectly detect said analyte by amperometry for a time period shorter than the ratio r²/D, where r is in metres and D is the diffusion coefficient of said analyte in m²/s, and measuring the resulting oxidation or reduction current at said integrated working electrode during this time period, so that only the analyte molecules submitted to a hemi-spherical or hemi-cylindrical diffusion regime above said at least one integrated working electrode are probed during the amperometric measurement;
and optionally
d) performing sequential amperometric measurements by repeating step c) after a relaxation time longer than half of the ratio r²/D.

2: An amperometric detection method for determining the presence, the amount and/or the concentration of an analyte in a microfluidic sensor comprising the steps of:
a) providing a microfluidic sensor comprising at least one microstructure including at least one working electrode integrated with precise size and location in one wall portion of said microstructure, the height of said microstructure above said integrated working electrode being at least twice the characteristic length—or the radius in the case of a circular electrode—r in metres of said integrated working electrode, and said microstructure exhibiting a recess of height L in metres above said at least one integrated working electrode;
b) filling said microfluidic sensor with the sample to analyse;
c) applying the potential required to directly or indirectly detect said analyte by amperometry for a time period shorter than the ratio (r+L)²/D, where D is the diffusion coefficient of said analyte in m²/s, and measuring the resulting oxidation or reduction current at said integrated working electrode during this time period, so that only the analyte molecules submitted to a hemi-spherical or hemi-cylindrical diffusion regime within said microstructure are probed during the amperometric measurement;
and optionally
d) performing sequential amperometric measurements by repeating step c) after a relaxation time longer than half of the ratio (r+L)²/D.

3. (canceled)

4: An amperometric detection method according to claim 2, wherein the potential is applied—and the related current measured—at said at least one integrated electrode during a time period of no more than about 2 seconds.

5: An amperometric detection method according to claim 1, wherein a relaxation time separating sequential amperometric measurements is longer than about 1 second but shorter than about 1 minute.

6: An amperometric detection method according to claim 1, wherein an effective detection signal considered for determining the presence, concentration and/or amount of an analyte in said microfluidic sensor is restricted to only a portion of the current measured during step c), and optionally step d), said portion of the measured current being selected over a time period where the capacitive current can be considered constant with respect to the faradic current and where are detected only analyte molecules submitted to a hemi-spherical or hemi-cylindrical diffusion regime.

7: An amperometric detection method according to claim 6, wherein the current measured during the first part of the potential application in step c), and optionally step d), is eliminated and not considered as the effective detection signal, said first part of the potential application having a duration of at least 1 second, or, in the case where said at least one integrated working electrode has a recess of length L, a duration at least equal to the ratio L²/2D.

8: An amperometric detection method according to claim 1, wherein an effective detection signal is obtained by integrating the current measured during step c), and optionally step d) over only a portion of the potential application period, so as to obtain a detection signal corresponding to the value of the charge Q in Coulombs resulting from the detection of analyte molecules submitted only to a hemi-spherical or hemi-cylindrical diffusion regime, and wherein the presences the amount and/or the concentration of said analyte is determined from the value of this charge Q.

9: An amperometric detection method according to claim 8, wherein the detection signal is obtained by eliminating the current measured during at least the first second of potential application, and by considering the charge Q corresponding to the integration of the measured current over the remaining duration of the potential application.

10: An amperometric detection method according to claim 4, wherein the detection signal is obtained by eliminating the current measured during a first potential application of duration at least equal to L²/2D, and by considering the charge Q corresponding to the integration of the measured current over the remaining duration of the potential application, and wherein the detection signal is obtained by considering the charge Q corresponding to the integration of the current measured over the time interval t=˜1 s and t=˜2 s.

11: An amperometric detection method according to claim 8, wherein the presence, the amount and/or the concentration of an analyte is determined from the time evolution of said charge Q over sequential amperometric measurements.

12. (canceled)

13: An amperometric detection method according to claim 1, wherein the detected analyte molecules are partially or totally regenerated during sequential amperometric measurements and/or during the relaxation time separating two sequential amperometric measurements.

14: An amperometric detection method according to claim 13, wherein the detected analyte molecules are partially or totally regenerated during the relaxation time separating two sequential amperometric measurements by inverting the potential applied to said at least one integrated working electrode to a value enabling to reduce, or respectively oxidise, the detected molecules back into analyte molecules that are then detectable during the next amperometric measurement.

15: An amperometric detection method according to claim 13, wherein the detected analyte molecules are partially or totally regenerated on at least one counter electrode integrated in at least one wall portion of said microstructure.

16: An amperometric detection method according to claim 13, wherein the presence, amount and/or concentration of an analyte is determined by considering the currents resulting from both said amperometric measurement(s) and said regeneration of the detected molecules.

17-19. (canceled)

20: An amperometric microfluidic sensor comprising at least one microstructure including:
a. at least one working electrode integrated with precise size and location in one wall portion of said microstructure, the height of said microstructure above said integrated working electrode being at least twice the characteristic length—or the radius in the case of a circular electrode—r of said integrated working electrode, and, optionally, said microstructure exhibiting a recess of length L in metres above said at least one integrated electrode,
b. at least one counter electrode or one pseudo-reference electrode integrated in one wall portion of said microstructure, characterised in that the distance between said at least one counter electrode or one pseudo-reference electrode and said at least one working electrode is smaller than twice the microstructure height,
said amperometric microfluidic sensor being adapted to detect signals resulting only from the analyte molecules submitted to a hemi-spherical or hemi-cylindrical diffusion regime above said at least one integrated working electrode upon application of the potential required to directly or indirectly detect said analyte by amperometry for a time period shorter than the ratio (r+L)²/D where D is the diffusion coefficient of said analyte in m²/s, and measuring the resulting oxidation or reduction current at said integrated working electrode during this time period.

21. (canceled)

22: An amperometric microfluidic sensor according to claim 20, wherein the ratio of the microstructure height over the characteristic length—or radius—of said at least one integrated working electrode is comprised between about 2 and 5.

23-34. (canceled)

35: An amperometric microfluidic sensor according to claim 20, wherein said microstructure comprises a plurality of working electrodes integrated with precise size and location in one wall portion of said microstructure, the height of said microstructure above said integrated working electrode being at least twice the characteristic length—or the radius in the case of a circular electrode—r of said integrated working electrodes, and the distance between two adjacent integrated working electrodes being equal or larger than twice their characteristic length—or radius in case of circular electrodes.

36-38. (canceled)

39: An amperometric microfluidic sensor according to claim 20, wherein said microstructure and/or said at least one integrated working electrode is/are fabricated by any one of physical or chemical etching, injection moulding, laser photoablation, polymer casting, UV-LIGA, embossing, silicon technology, assembly of a series of layers or any combination thereof.

40-43. (canceled)

44: An amperometric microfluidic sensor according to claim 20, wherein the reference or pseudo-reference electrode(s) is(are) placed in the reservoir(s) at the inlet and/or outlet of said microstructure, said microchannel or said array or network of microchannels.

45: An amperometric microfluidic sensor according to claim 20, wherein said microstructure and/or a reservoir surrounding said microstructure inlet or outlet comprise(s) at least one of a biological material and of a chemical compound or reagent.

46: An amperometric microfluidic sensor according to claim 45, wherein said biological material or chemical compound or reagent is dried and/or reversibly or irreversibly immobilised: either directly within said reservoir and/or within at least one portion of said microstructure such as on a wall portion or on said integrated working electrode(s); or on a support material like a membrane, a gel, a sol-gel or beads, placed either within said reservoir and/or within at least one portion of said microstructure.

47-51. (canceled)

52: A method of fabricating an amperometric microfluidic sensor comprising
a. at least one microstructure including at least one working electrode integrated with precise size and location in one wall portion of said microstructure, the height of said microstructure above said integrated working electrode being at least twice the characteristic length—or the radius in the case of a circular electrode—r of said integrated working electrode, and, optionally, said microstructure exhibiting a recess of height L in metres above said at least one integrated electrode,
b. at least one counter electrode or one pseudo-reference electrode integrated in one wall portion of said microstructure, characterised in that the distance between said at least one counter electrode or one pseudo-reference electrode and said at least one working electrode is smaller than twice the microstructure height,
said amperometric microfluidic sensor being adapted to detect signals resulting only from the analyte molecules submitted to a hemi-spherical or hemi-cylindrical diffusion regime above said at least one integrated working electrode upon application of the potential required to directly or indirectly detect said analyte by amperometry for a time period shorter than the ratio (r+L)²/D, where D is the diffusion coefficient of said analyte in m²/s, and measuring the resulting oxidation or reduction current at said integrated working electrode during this time period.

53-54. (canceled)

55: A method of fabricating an amperometric microfluidic sensor according to claim 52, wherein said integrated working, counter and/or pseudo-reference electrode(s) is(are) supported on conducting pad(s) placed on the material serving as microstructure support, on the opposite side of said microstructure and wherein said integrated working, counter, reference and/or pseudo-reference electrode(s) is(are) manufactured by elimination of material of the microstructure support at the bottom of said microstructure so as to create recessed electrode(s) at the bottom of said microstructure.

56-68. (canceled)

69: Use of an amperometric microfluidic sensor in conjunction with an amperometric detection method according to claim 1 for performing chemical and/or biological reactions in solution and particularly in connection with synthesis, and/or for performing chemical and/or biological analysis particularly in connection with chemical and/or biological assays such as but not limited to protein assays, affinity assays, immunoassays, enzymatic assays, enzyme-linked immunosorbent assays, cellular assays, virus assays, pathogen assays, DNA assays, hybridization assays, oligonucleotide assays, physico-chemical characterisation assays, lipophilicity assays, solubility assays or permeability assays, said sensor comprising at least one microstructure including:
a. at least one working electrode integrated with precise size and location in one wall portion of said microstructure, the height of said microstructure above said integrated working electrode being at least twice the characteristic length—or the radius in the case of a circular electrode—r of said integrated working electrode, and, optionally, said microstructure exhibiting a recess of length L in metres above said at least one integrated electrode, and
b. at least one counter electrode or one pseudo-reference electrode integrated in one wall portion of said microstructure, characterised in that the distance between said at least one counter electrode or one pseudo-reference electrode and said at least one working electrode is smaller than twice the microstructure height.

70-72. (canceled)

73: An amperometric microfluidic sensor according to claim 20, wherein said at least one working electrode is facing said at least one counter-electrode or one pseudo-reference electrode, so that said integrated working electrode is located on one face of a microstructure support of said amperometric microfludic sensor while said at least one counter-electrode or pseudo-reference electrode is located on the opposite face of the microstructure support of said amperometric microfluidic sensor.
